(19) United States
(12) Patent Application Publication
(10) Pub. No.: US 2017/0059151 A1
(43) Pub. Date: Mar. 2, 2017

(54) LUMINAIRE UTILIZING DISPLAY DEVICE AND ASSOCIATED ILLUMINATION COMPONENT(S)

(71) Applicant: ABL IP HOLDING LLC, Conyers, GA (US)

(72) Inventors: Mark A. Black, Lawsonville, NC (US); Jack C. Rains, JR., Herndon, VA (US); Ravi Kumar Komanduri, Dulles, VA (US); David P. Ramer, Reston, VA (US)

(21) Appl. No.: 15/296,634

(22) Filed: Oct. 18, 2016

Related U.S. Application Data
(63) Continuation-in-part of application No. 15/244,402, filed on Aug. 23, 2016.
(60) Provisional application No. 62/209,546, filed on Aug. 25, 2015.

(51) Int. Cl. F21V 33/00; F21V 14/00; H05B 37/02; H04N 9/31; G02F 1/1335; G09G 3/36; F21S 8/04; F21V 8/00

(52) U.S. Cl. CPC F21V 33/0052; F21S 8/043; F21V 14/003; G02B 6/0063; H04N 9/3141; G02F 1/133615; G02F 1/133524; G09G 3/36; H05B 37/02; F21Y 2115/10

(57) ABSTRACT

A luminaire includes a display oriented for image output in a first direction and one or more lighting device components oriented for emission of illumination light, for use in a different second direction. The light source may output the illumination light in a second direction or illumination light from the source may be directed into the second direction (e.g. be a lens, reflector, etc.). The second direction of light output is different from the first direction. In one example, the configurable luminaire is a suspended light fixture with a display facing downward and a separate light emitter for indirect illumination emitted/directed upward. The elements that generate the illumination light may be separate from the display components or may support an additional functions, such as backlight generation, for operation of the display.

### CROSS-REFERENCE TO OTHER APPLICATIONS

This application is a continuation-in-part of U.S. Utility patent application Ser. No. 15/244,402, entitled “ENHANCEMENTS FOR USE OF A DISPLAY IN A SOFTWARE CONFIGURABLE LIGHTING DEVICE,” filed Aug. 23, 2016; which Utility Application claims priority of U.S. Provisional Patent Application No. 62/209,546, filed on Aug. 25, 2015 and entitled “ENHANCEMENTS FOR USE OF A DISPLAY IN A SOFTWARE CONFIGURABLE LIGHTING DEVICE,” the entire contents of both of which applications are incorporated herein by reference.

### TECHNICAL FIELD

The present subject matter relates to a lighting device or luminaire, and/or operations thereof, where the luminaire includes a display oriented for image output in a first direction and one or more lighting device components oriented for emission of illumination light in a different second direction.

### BACKGROUND

Electrically powered artificial lighting has become ubiquitous in modern society. Electrical lighting devices are commonly deployed, for example, in homes, buildings of commercial and other enterprise establishments, as well as in various outdoor settings.

In conventional lighting devices, the luminance output can be turned ON/OFF and often can be adjusted up or dimmed down. In some devices, e.g. using multiple colors of light emitting diode (LED) type sources, the user may be able to adjust a combined color output of the resulting illumination. The changes in intensity or color characteristics of the illumination may be responsive to manual user inputs or responsive to various sensed conditions in or about the illuminated space. The optical distribution of the light output, however, typically is fixed. Various different types of optical elements are used in such lighting devices to provide different light output distributions, but each type of device has a specific type of optic designed to create a particular light distribution for the intended application of the lighting device. The dimming and/or color control features do not affect the distribution pattern of the light emitted from the luminaire.

To the extent that multiple distribution patterns are needed for different lighting applications, multiple luminaries must be provided. To meet the demand for different appearances and/or different performance (including different distributions), a single manufacturer of lighting devices may build and sell thousands of different luminaries.

Some special purpose light fixtures, for example, fixtures designed for stage or studio type lighting, have implemented mechanical adjustments. Mechanically adjustable lenses and irises enable selectable adjustment of the output light beam shape, and mechanically adjustable gimbal fixture mounts or the like enable selectable adjustment of the angle of the fixture and thus the direction of the light output. The adjustments provided by these mechanical approaches are implemented at the overall fixture output, provide relatively coarse overall control, and are really optimized for special purpose applications, not general lighting.

There have been more recent proposals to develop lighting devices offering electronically adjustable light output characteristics, for example, using a number of separately selectable/controllable solid state lamps or light engines within one light fixture. In at least some cases, each internal light engine or lamp may have an associated adjustable electro-optic component to adjust the respective light beam output, thereby providing distribution control for the overall illumination output of the fixture.

Although the more recent proposals provide a greater degree of distribution adjustment and may be more suitable for general lighting applications, the outward appearance of each lighting device remains the same even as the device output light distribution is adjusted. Hence, there may be room for still further improvement in the ability to adjust or configure the luminaire, for variations in performance and/or in appearance of the luminaire.

There also have been proposals to use displays or display-like devices mounted in or on the ceiling to provide variable lighting. The Fraunhofer Institute, for example, has demonstrated lighting equipment using luminous tiles, each having a matrix of red (R) LEDs, green (G), blue (B) LEDs and white (W) LEDs as well as a diffuser film to process light from the various LEDs. The LEDs of the system were driven to simulate or mimic the effects of clouds moving across the sky. Although use of displays allows for variations in appearance that some may find pleasing, the displays or display-like devices are optimized for image output and do not provide particularly good illumination for general lighting applications. A display typically has a Lambertian output distribution over substantially the entire surface area of the display screen, which does not provide the white light intensity and coverage area at a floor or ceiling height offered by a similarly sized ceiling-mounted light fixture. Liquid crystal displays (LCD) also are rather inefficient. For example, backlights in LCD televisions have to produce almost ten times the amount of light that is actually delivered at the viewing surface. Therefore, any LCD displays that are to be used as lighting products need to be more efficient than typical LCD displays for the lighting device implementation to be commercially viable.

### SUMMARY

Hence, for any or all of the reasons outlined above or other reasons, there is room for further improvement in lighting devices or luminaries, particularly those using or based on display devices.

For example, a luminaire may include a display device as well as a light source co-located with the display device so that the display device and the light source are both elements of the luminaire. The display device produces an image display output in a first direction. The light source produces an illumination light output, which may be output in or directed into a second direction different from the first direction.

In several specific implementations discussed below, the light source is configured to produce the illumination light output, in the second direction, with industry acceptable performance for a general lighting application.

The example also encompasses lighting devices that combine such luminaries with other components as well as systems that include one or more such lighting devices.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a simplified diagram of a luminaire that includes a display device and one or more light source components emitting light for a general illumination application.

FIGS. 2A and 2B are side and isometric views respectively of a somewhat different example of a luminaire combining a display device and components forming an illumination light source.

FIG. 3 is high-level functional block diagram of an example of a configurable lighting device or apparatus that includes a luminaire of the type discussed in the examples in the detailed description below.

FIG. 4 is a plan view of a display device, enhanced with one or more sources that may be implemented in a luminaire.

FIGS. 5A and 5B are partial cross-sectional views in the vicinity of one corner (roughly along line A-A of FIG. 4) of a luminaire, showing an angled arrangement and a horizontal arrangement respectively of a light source panel with a display device and additional illumination light output components.

FIGS. 5C and 5D are partial cross-sectional views in the vicinity of one corner (roughly along line A-A of FIG. 4) of a luminaire, similar to the views in FIGS. 5A and 5B, but showing alternative configurations with some light output from each luminaire emitted in other example directions (e.g. some upward in the illustrated orientations).

FIG. 5E is an enlarged cross-sectional view along line B-B of FIG. 4, for another example of a configurable lighting device with a display device and illumination light output components.

FIGS. 6 and 7 illustrate different examples of luminaries that each include a display device and an illumination light source, where the display is curved.

FIGS. 8 and 9 show different examples of luminaries, each of which uses a projector and screen as the display.

FIGS. 10 and 11 depict different examples of luminaries each using a liquid crystal device (LCD) panel and a light waveguide for backlighting the LCD, as the display device, with different implementations of the light source to provide both illumination and light input to the light waveguide for backlighting the LCD.

FIG. 12 is a high-level functional block diagram of a system for providing configuration or setting information to a configurable lighting device, e.g. based on a user selection.

FIG. 13 is a ping-pong chart type signal flow diagram, of an example of a procedure for loading configuration information to a configurable lighting device, in a system like that of FIG. 12.

FIG. 14 is a simplified functional block diagram of a computer that may be configured as a host or server, for example, to supply configuration information or other data to a software configurable lighting apparatus, such as that of FIG. 3, e.g., in a system like that of FIG. 12.

FIG. 15 is a simplified functional block diagram of a personal computer or other similar user terminal device, which may communicate with a software configurable lighting apparatus.

FIG. 16 is a simplified functional block diagram of a mobile device, as an alternate example of a user terminal device, for possible communication with a software configurable lighting apparatus.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various examples disclosed herein relate to or incorporate that includes a display device as well as a light source co-located with the display device so that the display device and the light source are both elements of the luminaire. The display device is configured to produce an image display output in a first direction. The light source is configured to produce an illumination light output. The illumination light output from the source may be emitted in or directed (e.g. by optical component(s)) towards a second direction different from the first direction. A variety of examples of such luminaries are shown in the drawings and discussed in detail below. Examples of lighting devices, e.g. luminaire in combination with relevant circuitry or other components, also are covered, as well as examples of systems that enable networked communication to and/or from such a lighting device.

The illumination light output of a luminaire, for example, may have an intensity and/or other characteristic(s) that satisfy an industry acceptable performance standard for a general lighting application.

The term “luminaire,” as used herein, is intended to encompass essentially any type of device that processes energy to generate or supply artificial light, for example, for general illumination of a space intended for use of or occupancy or observation, typically by a living organism that can take advantage of or be affected in some desired manner by the light emitted from the device. However, a luminaire may provide light for use by automated equipment, such as sensors/monitors, robots, etc. that may occupy or observe the illuminated space, instead of or in addition to light provided for an organism. However, it is also possible that one or more luminaries in or on a particular premises have other lighting purposes, such as signage for an entrance or to indicate an exit. In most examples, the luminaire(s) illuminate a space or area of a premises to a level useful for a human in or passing through the space, e.g. general illumination of a room or corridor in a building or of an outdoor space such as a street, sidewalk, parking lot or performance venue. The actual source of illumination light in or supplying the light for a luminaire may be any type of artificial light emitting device, several examples of which are included in the discussions below.

Terms such as “artificial lighting,” as used herein, are intended to encompass essentially any type of lighting that a device produces light by processing of electrical power to generate the light. An artificial lighting device, for example, may take the form of a lamp, light fixture, or other luminaire that incorporates a light source, where the light source by itself contains no intelligence or communication capability, such as one or more LEDs or the like, or a lamp (e.g. “regular light bulbs”) of any suitable type.

In the examples below, the luminaire includes at least one or more components forming a lighting source for generating the artificial illumination light for a general lighting application as well as a co-located display device, e.g. integrated/combined with the lighting component(s) of the lighting source into the one structure of the luminaire. In several illustrated examples, such a combinatorial luminaire takes the form of a light fixture, such as a pendant or drop light or a downlight, or wall wash light or the like. Other fixture mounting arrangements are possible. For example, at least some implementations of the luminaire may be surface mounted on or recess mounted in a wall, ceiling or floor. The luminaire with the lighting component(s) and the display device may take other forms, such as lamps (e.g. table or floor lamps or street lamps) or the like. Additional devices, such as fixed or controllable optical elements, may be included in the luminaire, e.g. to distribute light output from the display device and/or the illumination light source.

The term “display device” as used herein is intended to encompass essentially any type of device that selective processes energy to controllably output light representing an image. Display devices may or may include light generating elements. A pixel is a unit area of an image. On a display device, for example, a pixel is point or small unit of area of light as part of an image presented in the image display output. A display device may be selectively controlled to emit light of a different color and intensity as each pixel point/area of the image display output. The image output light may be generated directly by the display pixels (e.g. by direct emissions from LEDs or plasmas at the pixels), by controlled filtering of source light (e.g. by red, green, blue LCD filters at the pixels), or by reflection of source light (e.g. by electrophoretic ink pixels). In other examples of the image display device, a projector of any suitable type may project the display image onto a transmissive or reflective screen. In this later case, the combination of the projector and screen form the display. In a further alternative example, the projector (alone) may be the display device located/configured to output light to project the image onto a structural surface (e.g. wall or ceiling) not itself a component of the luminaire.

Terms such as “lighting device” or “lighting apparatus,” as used herein, are intended to encompass essentially any combination of an example of a luminaire discussed below with other elements such as electronics and/or support structure, to operate and/or install the particular luminaire implementation. Such electronics, for example, may include some or all of appropriate driver(s) for the illumination light source and the display device, any associated control processor, and/or data communication interface(s). As noted, the lighting component(s) and display device are co-located into an integral unit, such as a light fixture or lamp implementation of the luminaire. The electronics for driving and/or controlling the lighting component(s) and the display device may be incorporated within the luminaire or located separately and coupled by appropriate means to the light source component(s) and the display device.

The term “lighting system,” as used herein, is intended to encompass essentially any type of system that either includes a number of such lighting devices coupled together for data communication or a lighting device coupled together for data communication with one or more control devices, such as wall switches, control panels, remote controls, central lighting or building control systems, etc.

In several of the examples, the luminaire is software configurable, by programming instructions and/or setting data, e.g. that may be communicated to a processor of the lighting device via a data communication network of a lighting system. Configurable aspects of lighting device operation may include one or more of: a selected image (still or video) for presentation as the image output from the display device, and one or more parameters (such as intensity and various color related characteristics) of the illumination light. If the luminaire also includes a system for variably controlling or modulating the light output distribution, as in several example, one or more parameters of the output distribution (e.g. beam shape and beam angle) also would be configurable. A software configurable lighting device, with the luminaire thereof installed for example as a panel or pendant type light fixture, offers the capability to emulate a variety of different lighting devices for general lighting applications, while presenting any desired appearance via image display.

The term “coupled” as used herein refers to any logical, physical or electrical connection, link or the like by which signals produced by one system element are imparted to another “coupled” element. Unless described otherwise, coupled elements or devices are not necessarily directly connected to one another and may be separated by intermediate components, elements or communication media that may modify, manipulate or carry the signals.

Light output from the luminaire may carry information, such as a code (e.g. to identify the luminaire or its location) or downstream transmission of communication signaling and/or user data. The light based data transmission may involve modulation or otherwise adjusting parameters (e.g. intensity, color characteristic or distribution) of the illumination light out or an aspect (e.g. modulation of backlighting and/or adding a detectable code to portion of a displayed image) of the light output from the display device.

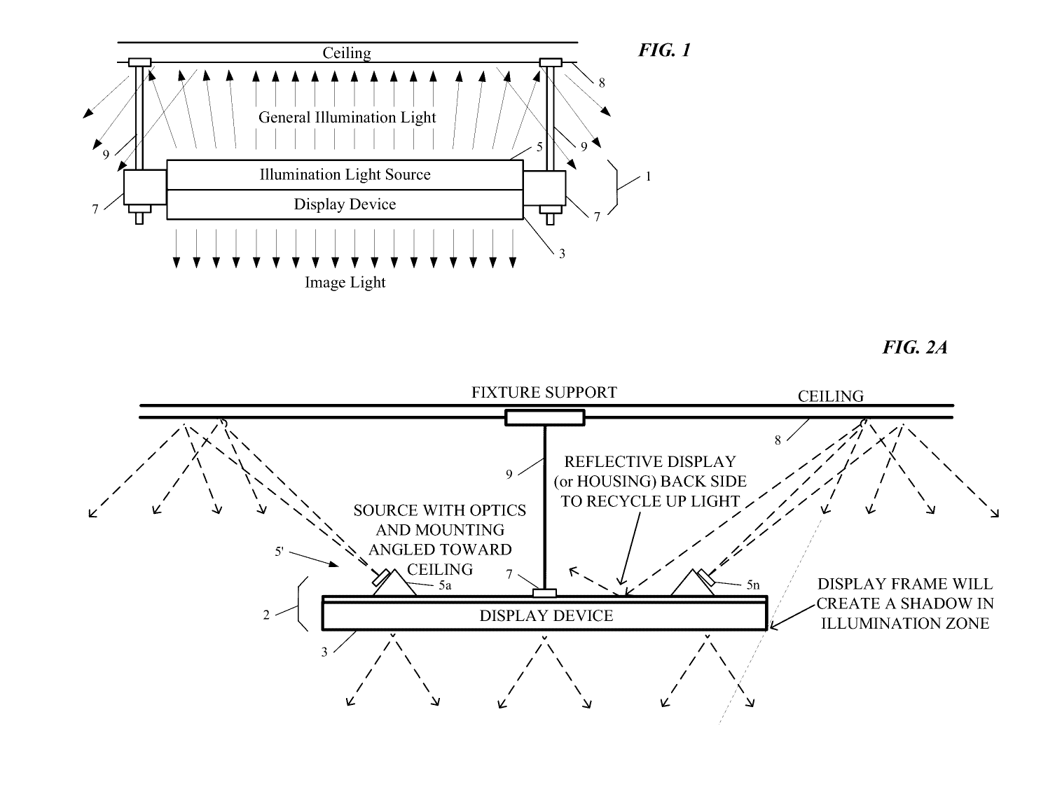

Reference now is made in detail to the examples illustrated in the accompanying drawings and discussed below. FIG. 1 illustrates the elements of a first example of a luminaire 1. In the first example, the luminaire 1 is a suspended light fixture, e.g. a drop light.

The luminaire 1 includes a display device 3 as well as a light source 5 co-located with the display device 3 so that the display device 3 and the light source 5 are both elements of the luminaire 1. The display device 3 and the illumination light source 5 may be attached to or mounted in a common luminaire housing (not separately shown). The housing (or the display device 3 and/or the light source 5) includes or is attached to one or more support brackets 7, which provide attachment points for support(s), shown by way of example as rods or cables 9 in the first drawing. A variety of different arrangements or structures may be used in place of the housing, the brackets 7 and the rods/cables 9 to support the luminaire 1 at a desired height, in this example, below a location on the ceiling 8.

The display device 9 is configured to produce an image display output in a first direction. Any suitable display device may be used, such as a flat panel liquid crystal device (LCD) type display, a light emitting diode (LED) display, an organic light emitting diode (OLED) display, etc. Display devices of other shapes structures are shown and discussed relative to later examples. In the example of FIG. 1, the display device 9 is positioned below the ceiling 8 and oriented so as to emit the light for the displayed image downward. For other application examples, the display device 9 may have a different orientation to emit image light in different direction. The present examples also encompass arrangements that project the image onto another source, e.g. a surface of the ceiling, floor or other building structure in the vicinity of the luminaire. The direction of the image output, however, typically will enable a human observer to see and perceive the displayed image, for example at the display output or on a surface receiving a projected image, from at least some portions of the space illuminated by the luminaire 1.

The illumination light source 5 is configured to produce illumination light output, in this first example, with industry acceptable performance for a general lighting application. For example, for task lighting, the source 5 may produce a white light emitted toward a diffusely reflective ceiling surface of intensity sufficient that the light reflected downward from the ceiling 8 meets typical requirements for task lighting at a counter, desktop or floor level below the particular ceiling level.

The illustration shows arrows representing the image light output from the display device 3 in a first downward direction and the illumination light output produced by the light source 5 in a different second (generally upward) direction. The arrows show an implementation in which the light generation by source 5 and display device 3 are independent of each other, in that light from one is not shared with/used by the other in the generation of the respective light outputs. In such an implementation, for example, the display device 3 may include its own light generation system, e.g. a backlight or individual pixel level light generators. Such an arrangement, however, is a non-limiting example. The present concepts also encompass arrangements in which some light is shared between the illumination light source 5 and the display device 3. For example, if the display device 3 uses a controllable LCD panel requiring backlighting, the illumination light source 5 may be an OLED panel or the like configured to supply the backlighting to the LCD panel, in addition to providing the general illumination light output.

The illumination light source 5 may be adjustable in various ways. For example, source 5 may be selectively controlled for dimming of the downlight intensity and/or to control the color characteristic of the emitted light and thus the light reflected downward from the ceiling 8.

A variety of sources may be used, alone or in combination with other optical elements (not shown in this first illustration). The light source 5, for example, may be a flat panel fluorescent lamp, an LED or OLED type light panel or the like. Although shown as a single flat panel source of size similar to the display device, in this first example, a different sized source or a number of discrete sources may be used to form the overall illumination light source 5, for example, for different intended illumination applications of the luminaire 1. The light source 5 may extend across a substantial portion or all of the back surface (top surface in the illustrated orientation) of the display device 3 as shown, or the source 5 may be formed along limited areas of the display device surface or only at one or more discrete locations adjacent to that display device surface.

The illumination light output from the source 5 may be emitted in or directed (e.g. by optical component(s)) towards a second direction different from the first direction of the output of the image display light from the display device 9. In the example, the source 5 emits light in the second direction. In other examples shown/described later, one or more optical components are included in the luminaire to direct the illumination light from particular source components into the second direction. For example, the illumination light source 5 may have or be coupled to a reflector and/or one or more lenses etc. to direct and distribute the illumination light as appropriate for a particular intended illumination applications of the luminaire 1. Also, the source structure and/or the optical element(s) added to the source may enable selective control of the distribution (e.g. angle and/or shape) of the general illumination light output of the luminaire 1.

Although the light output from the illumination light source 5 may pass in other directions, in the illustrated example, the light source 5 emits at least a substantial portion of the illumination light output upwards towards the ceiling 8. Such an output from the illumination light source 5 is substantially opposite the direction (downward) of the image light output of display device 3. If the ceiling 8 is somewhat reflective, e.g. diffusely reflective white or pastel in color, much of the illumination light output from the light source 5 is reflected down and distributed around the perimeter of the luminaire for indirect downward illumination.

In this example, the configurable luminaire 1 provides a controllable downward display function. The display may output any still image or video, such as a still image of a sky or imagery of moving clouds in the sky or virtually any scene or video image desired by presentation in a particular space served by the luminaire 1.

The downward display and upward illumination light output are shown by way of example, and other orientations are feasible. For example, if the luminaire used a projector type display device and was inverted, the projector may present the image on the ceiling 8 while the illumination light source provides general illumination light output downward away from the ceiling 8.

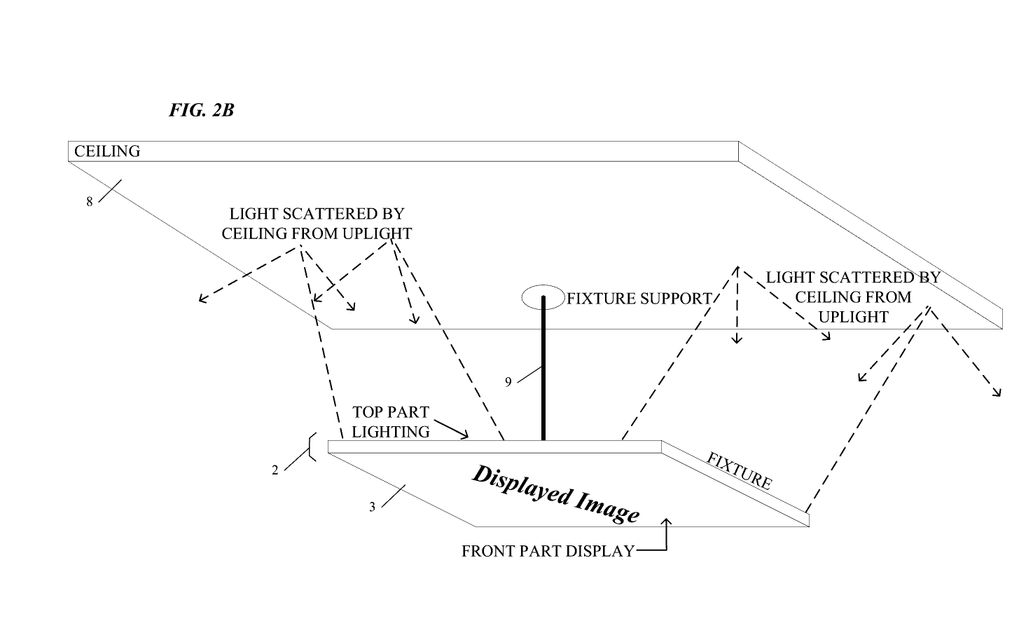

FIGS. 2A and 2B are side and isometric views respectively of a somewhat different example of a luminaire 2 combining a display device and components forming an illumination light source. Similar to the example of FIG. 1, the luminaire 2 includes a display device 3 oriented to emit image display light downward from the luminaire 2. In this example, the display device 3 is a flat panel display, such as a: LCD display, OLED display, LED display, plasma display, etc. In this second example, however, the luminaire 2 includes a light source 5′ formed of a number of individual light sources 5a to 5n mounted on or adjacent to the back surface of the display device 3 or the housing (if separately provided) of the luminaire 2. Each of the light sources 5a to 5n may be an LED or an OLED, for example, coupled to fixed or variable optics for supplying light of desired distribution in one or more second directions (different from the direction of the light of the display image output). Other light sources and display devices may be used instead of or in addition to those noted here.

In the example of FIG. 1, the drop light fixture type luminaire 1 was hung below the ceiling 8 by multiple support rods or cables 9 attached to a number of brackets 7 on the luminaire 1. The example of FIGS. 2A and 2B represents a pendant type light fixture implementation of the luminaire 2 in which the fixture has a single bracket 7 or the like, on the surface opposite the display output, providing an attachment point for a single strut attached to or through the ceiling 8.

Other aspects of structure, orientation and operation of the luminaire 2 are generally similar to those of the luminaire 1 discussed above.

In a luminaire like 1 with a broad illumination light source directing light toward the ceiling 8, the luminaire itself obstructs some light reflected back from the ceiling 8, creating shadow effect with respect to general illumination. The arrangement and orientation of the light source components 5a to 5n in the example of a luminaire 2 in FIGS. 2A and 2B may reduce this blockage and shadow effect relative to illumination light output from the light source 5′.

If the fixture is suspended low enough, and the light aimed at the ceiling 8 is wide enough in angle, scattered intensity may be reduced and display contrast may be good. Also, the separate locations of the light source and the display device and the separate directions of light outputs directions from the light source and the display device improves contrast when looking directly at the image display output. The displayed image may to be corrected by electronic processing to not affect overall color quality since lighting path to target is longer than that of display.

For suspended applications like those in FIGS. 1 to 2B, the display device can be selected to be light in weight to be supported properly, e.g. to reduce the size and/or complexity of the brackets and supports used to suspend the fixture below the ceiling 8. All wiring may reach the luminaire 1 or 2 through the support(s). Location of electronics should be decided (e.g. in ceiling or on fixture) size and weight considerations, since fixture weight may be an issue. For example, the electronics of the lighting device may be in the suspended luminaire portion or included in or near the support structure in our above the ceiling 8 to reduce the weight held below the ceiling by the support(s) and bracket(s).

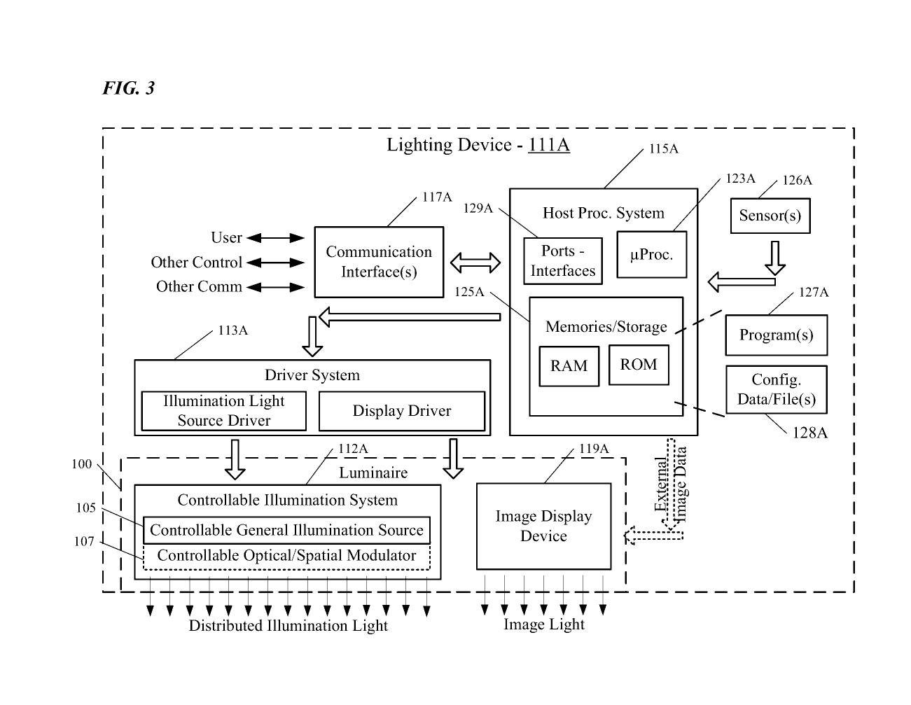

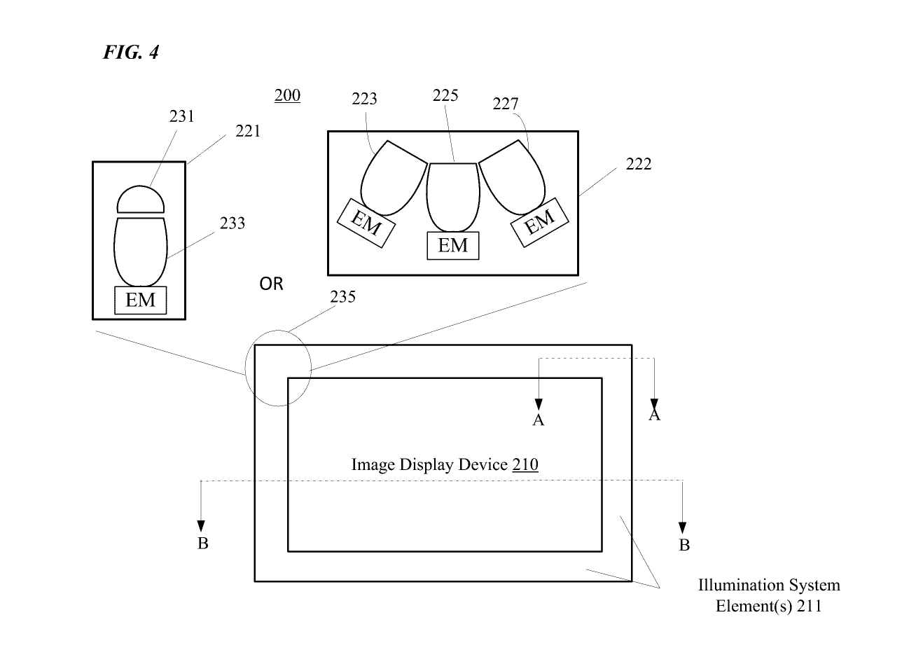

FIG. 3 is a block diagram of a lighting device 111A that includes a luminaire 100 of the type under consideration here. The luminaire 100 may be similar to the luminaire 1 or 2 discussed in the earlier examples or of a type discussed in several later examples relative to FIGS. 4 to 11. For illustration and discussion purposes, the luminaire 100 of the lighting device 111A includes a controllable illumination system 112A that includes one or more light source components forming a general illumination light source 105 and optionally may include other components for controlling the illumination light output of the light source(s)/device, such as the illustrated controllable optical/spatial modulator 107. The luminaire 100 of the lighting device 111A also includes an image display device 119A.

As shown in FIG. 3, the controllable illumination system 112A provides general illumination lighting in response to control signals received from the driver system 113A. Similarly, the image display device 119A provides image light in response to control signals received from the driver system 113A. In addition or alternatively, the image data may be provided to the image display device 119A from an external source(s) (not shown), such as a remote server or an external memory device via one or more of the communication interfaces 117A.

The functions of elements 112A and 119A are controlled by the control signals received from the driver system 113A. The driver system 113A may be an integral unit generating appropriate drive signals for operation of the light source(s) and any other components of the controllable illumination system 112A and of the image display device 119A; or as illustrated, the driver system 113A may include an illumination light driver system coupled to provide drive signal(s) to operate the light source(s) and any other components of the controllable illumination system 112A and a separate display driver to provide drive signals to operate the image display device 119A. Where the controllable illumination system 112A a controllable optical/spatial modulator 107, the illumination light source driver may provide signals to control the actual component(s) of the source 105 and to control the components of the modulator 107, or there may be separate drivers for the source and modulator.

The image display device 119A may be either a commercial-off-the-shelf image display device or an enhanced display device. Light from the source(s) and any optics forming the general illumination system 112A alone or in combination with image output light from the image display device 119A provides general illumination lighting that complies with governmental building codes and/or industry lighting standards. The image display device 119A is configured to present an image. The presented image may be a real scene, a computer generated scene, a single color, a collage of colors, a video stream, animation or the like. The controllable illumination system 112A may be an otherwise standard general illumination system, which is co-located with the image display device 119A, and that includes one or more light sources that provide general illumination that satisfies the governmental building codes and/or industry lighting standards.

FIG. 3 also provides an example of an implementation of the high layer logic and communications elements to control luminaire operations to provide selected illumination light, e.g. for a general illumination application, and to provide a selected display image output. As shown in FIG. 3, the example 111A of the lighting device includes a host processing system 115A, one or more sensors 121A and one or more communication interface(s) 117A.

The host processing system 115A provides the high level logic or “brain” of the device 11. In the example, the host processing system 115A includes data storage/memories 125A, such as a random access memory and/or a read-only memory, as well as programs 127A stored in one or more of the data storage/memories 125A. The data storage/memories 125A store various data, including lighting device configuration information 128A or one or more configuration files containing such information, in addition to the illustrated programming 127A. The host processing system 115A also includes a central processing unit (CPU), shown by way of example as a microprocessor (μP) 123A, although other processor hardware may serve as the CPU.

The ports and/or interfaces 129A couple the processor 123A to various elements of the device 111A logically outside the host processing system 115A, such as the driver system 113A, the communication interface(s) 117A and the sensor(s) 121. For example, the processor 123A by accessing programming 127A in the memory 125A controls operation of the driver system 113A and other operations of the lighting device 111A via one or more of the ports and/or interfaces 129A. In a similar fashion, one or more of the ports and/or interfaces 129A enable the processor 123A of the host processing system 115A to use and communicate externally via the interface(s) 117A; and the one or more of the ports 129A enable the processor 123A of the host processing system 115A to receive data regarding any condition detected by a sensor 121A, for further processing.

In the operational examples, based on its programming 127A, the processor 123A processes data retrieved from the memory 123A and/or other data storage, and responds to light output parameters in the retrieved data to control the light generation and optionally the light distribution from illumination system 112A. The light output control also may be responsive to sensor data from a sensor 121A. The light output parameters may include light intensity and light color characteristics of light from source 105 in addition to spatial distribution control via modulator 107 (e.g. steering and/or shaping and the like for achieving a desired spatial distribution).

As noted, the host processing system 115A is coupled to the communication interface(s) 117A. In the example, the communication interface(s) 117A offer a user interface function or communication with hardware elements providing a user interface for the device 111A. The communication interface(s) 117A may communicate with other control elements, for example, a host computer of a building control and automation system (BCAS). The communication interface(s) 117A may also support device communication with a variety of other equipment of other parties having access to the lighting device in an overall lighting system, e.g. equipment of the device manufacturer for maintenance or an on-line server for downloading of programming instruction or configuration data for setting aspects of luminaire operation.

As outlined earlier, the host processing system 115A also is coupled to the driver system 113A. The driver system 113A is coupled to the light source 105 and the spatial modulator 107 to control one or more operational parameter(s) of the light output generated by the source 105 and to control one or more parameters of the modulation of that light by the spatial modulator 107. Although the driver system 113A may be a single integral unit or implemented in a variety of different configurations having any number of internal driver units, the example of system 113A may include separate general illumination source driver circuit and spatial modulator driver circuit (not shown) and a separate image display driver. The separate drivers may be circuits configured to provide signals appropriate to the respective type of light source 105 and/or modulators 107 of the general illumination system 112A utilized in the particular implementation of the device 111A, albeit in response to commands or control signals or the like from the host processing system 115A.

The host processing system 115A and the driver system 113A provide a number of control functions for controlling operation of the lighting device 111A. In a typical example, execution of the programming 127A by the host processing system 115A and associated control via the driver system 113A configures the lighting device 111A to perform functions, including functions to operate the light source 105 to provide light output from the lighting system 112A and to operate the spatial modulator 107 to steer and/or shape the light output from the source 105 so as to distribute the light output from the lighting device 111A to emulate a light characteristics and/or lighting distribution of a selected one of a number of types of luminaries or lighting devices, based on the lighting device configuration information 128A.

In an example of the operation of the lighting device 111A, the processor 123A receives a configuration file 128A via one or more of communication interfaces 117A. The processor 123 may store, or cache, the received configuration file 128 in storage/memories 125.

The configuration file 128A includes configuration data that indicates, for example, an image for display by the image display device 119A as well as lighting settings for light to be provided by the controllable illumination system 112A. Each configuration file may also include software control data to set the light output parameters of the controllable illumination system 112A, at least with respect to one or more operational parameters for the controllable illumination light source 105 and possibly optical/spatial modulation parameters (e.g. regarding angle a shape) for control of the modulator 107.

Using the indicated image data, the processor 123A may retrieve from memory 125A stored image data, which is then delivered to the driver system 113A. The driver system 113A may deliver the image data directly to the image display device 119A for presentation or may have to convert the image data into a signal or data format suitable for delivery to the image display device 119A. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (Exif) or the like. For example, if floating point precision is needed, options are available, such as OpenEXR, to store 32-bit linear values. In addition, the hypertext transfer protocol (HTTP), which supports compression as a protocol level feature, may also be used.

As mentioned, the configuration information in the file 128A may specify operational parameters of the controllable illumination system 112A, such as light intensity, light color characteristic, image parameters and the like for light from the source 105, as well as the operating state of any light processing and modulation components of the optical/spatial modulator 107. The processor 123A by accessing programming 127A and using software configuration information 128A, from the storage/memories 125A, controls operation of the driver system 113A, and through that driver system 113A controls the illumination light source 105 and the modulator 107, e.g. to achieve a predetermined illumination light output intensity and/or color characteristic and possibly a predetermined light output distribution for a general illumination application of the lighting device 111A.

A software configurable lighting device such as 111A may be reconfigured, e.g. to change the image display output and/or to change one or more parameters to the illumination light output by changing the corresponding aspect(s) of the configuration data file 128A, by replacing the configuration data file 128A, or by selecting a different file from among a number of such files already stored in the data storage/memories 125A.

In other examples, the driver system 113A is coupled to the memory 125, the image display device 119A and the controllable illumination system 112A to control light generated by the image display device 119A and the controllable illumination system 112A based on the configuration data 128A stored in the memory 125A. In such an example, the driver system 113A is configured to directly access configuration data 128A stored in the memory 125A and generate control signals for presenting the image on the image display device 119A and control signals for generating light for output from the general illumination system 112A.

A lighting device 111A may be programmed to transmit information on the light output from the luminaire 100. Examples of information that the device 111A may transmit in this way include a code, e.g. to identify the luminaire 100 and/or the lighting device 111A or to identify the luminaire location. Alternatively or in addition, the light output from the luminaire 100 may carry downstream transmission of communication signaling and/or user data. The data transmission may involve adjusting or modulating parameters (e.g. intensity, color characteristic or distribution) of the illumination light output of the illumination system 112A or an aspect of the light output from the display device 119A. Transmission from the display device 119A may involve modulation of the backlighting of the particular type of display device. Another approach to light based data transmission from the display device 119A may involve inclusion of a code representing data in a portion of a displayed image. The modulation or image coding typically would not be readily apparent to a person in the illuminated area observing the luminaire operations but would be detectable by an appropriate receiver. The information transmitted and the modulation or image coding technique may be defined/controlled by configuration data or the like in the memories/storage 125A. Alternatively, user data may be received via one of the interfaces 117A and processed in the device 111A to transmit such received user data via light output from the luminaire 100.

Apparatuses implementing functions like those of configurable lighting device 111A may take various forms. In some examples, some components attributed to the lighting device 111A may be separated from the controllable image generation and illumination system 112A and image display device 119A of the luminaire 100. For example, a lighting device may have all of the above hardware components on a single hardware device as shown or in different somewhat separate units. In a particular example, one set of the hardware components may be separated from one or more instances of the controllable luminaire 100, such that the host processing system 115A may run several luminaries having displays, illumination light sources and possibly modulators from a remote location. Also, one set of intelligent components, such as the microprocessor 123A, may control/drive some number of driver systems 113A and associated controllable luminaries 100. It also is envisioned that some lighting devices may not include or be coupled to all of the illustrated elements, such as the sensor(s) 121A and the communication interface(s) 117A. For convenience, further discussion of the device 111A of FIG. 3 will assume an intelligent implementation of the device that includes at least the illustrated components.

In addition, the luminaire 100 of each lighting device 111A is not size restricted. For example, each luminaire 100 may be of a standard size, e.g., 2-feet by 2-feet (2×2), 2-feet by 4-feet (2×4), or the like, and arranged like tiles for larger area coverage. Alternatively, one luminaire 100 may be a larger area device that covers a wall, a part of a wall, part of a ceiling, an entire ceiling, or some combination of portions or all of a ceiling and wall.

Lighting equipment like that disclosed the examples of FIG. 3, may be used with various implementations of the luminaire 100. Although several examples of the luminaire implementations have been discussed above, it may be helpful to consider additional examples.

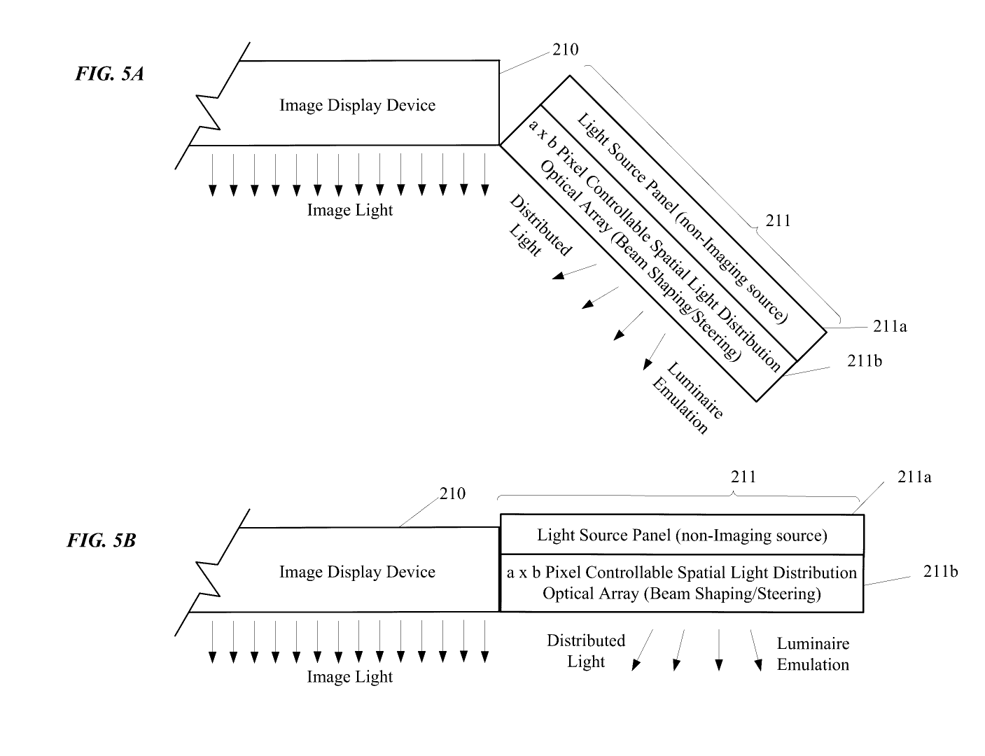

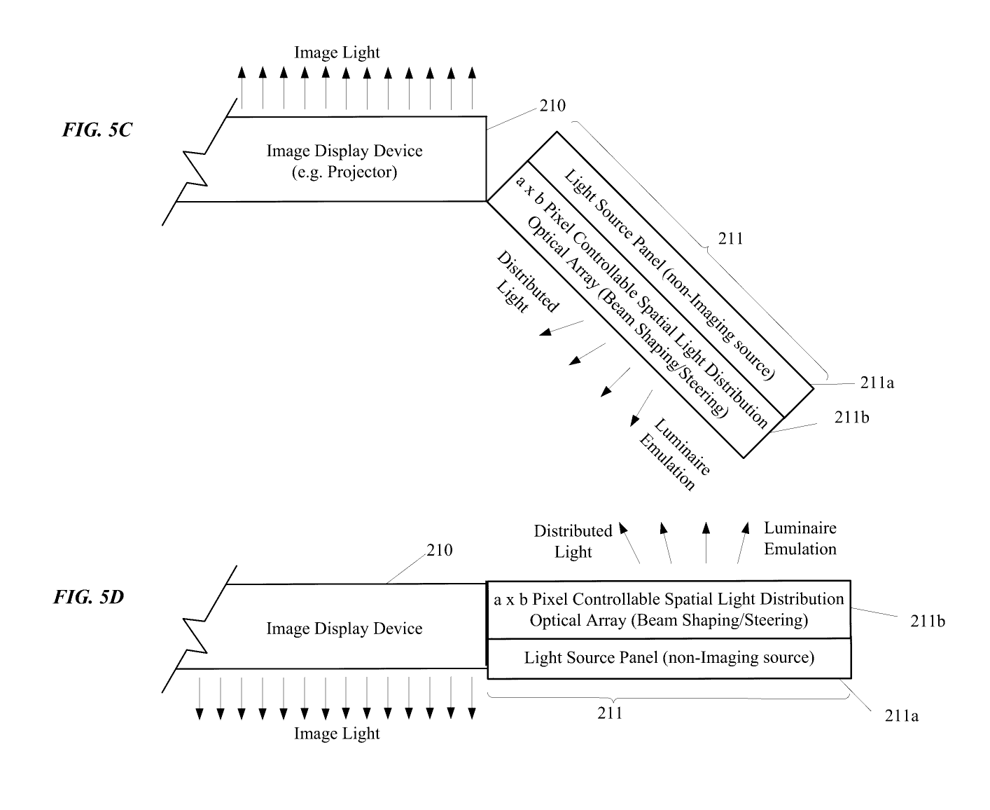

For this purpose, FIG. 4 is a plan view of a display device 200A, enhanced by combination thereof with elements 221A of a general illumination system, each element having one or more additional light sources and/or controllable optics. As will be discussed with respect to the more specific examples of FIGS. 5A and 5B, each of the added element of the general illumination system may be configured as a light source panel, and each panel may include a pixelated spatial modulator array (compare to FIG. 4).

Referring to FIG. 4, the luminaire 200 may be a panel design providing an image display device 210 with a general illumination system elements 211 co-located with, e.g., about the perimeter, or on one or more sides or portions, of, the display device 210. In the example of FIG. 4, the image display device 210 may be a display device that is an organic light emitting diode display device, non-organic light emitting diode display device, a plasma display device, and a liquid crystal display device.

The additional elements of the illumination system 211, in an example, are configured to form an array of light sources, such as light sources 221 and 222. The light sources 221, 222 may be arranged along some or all of the edge(s) around the periphery of the display device 210. In one or more examples, the general illumination system 211 may include one or more light sources, such as 221 and/or 222, that surround the image display device 210, or is co-located at a portion of the periphery of the image display device 210. In other examples, the general illumination system 211 uses a number of individually controllable light sources, such as 221 or 222, located on at least one side of the image display device 210. In yet another alternative arrangement, the light sources 221, 222 may be positioned in openings through the display device. For example, the light sources 221, 22 may be punched through or physically interlaced (e.g., in a checkerboard pattern) through the display device 210.

In FIG. 4, the circle 235 near one corner of the area of the illumination system 211 indicates an example of an area that may include one or more of the illumination light source components, e.g. one or more of light sources 221 or 222. The drawing also includes enlarged illustrations of two examples of different types of sources 221 or 222 that may be included in region 235. Orientations of the sources 221, 222 in the drawing are for ease of illustration only and do not indicate the actual orientation thereof in a particular illumination system 211 or the direction(s) of light output from either example source 221 or 222. Each type of light source 221 or 222 includes one or more actual light emitters (EM) that generate illumination light. In these examples, the emitters EM would be of the same type with a desired color characteristic for general illumination, for example, white LEDs of a particular correlated color temperature (CCT). Of course, other types of emitters may be used, for example, of different structures or producing light of multiple color characteristics.

In the example of source 221, the source includes a single light emitter EM and a total internal reflect (TIR) lens 233 optically coupled to receive light from the emitter EM. If only the lens 233 is included with the light emitter EM, the light source 221 may have some preset beam steering and/or beam shaping of the illumination light by the lens 233, e.g. in a particular direction and/or with particular beam shape of light output from each such source 221. Additional fixed optics (not shown) may be included. In the example, however, the light source 221 is shown with an additional spatial optical modulator element 231, such as a controllable eletrowetting lens 231, that provides an optical spatial modulation capability with respect to the light output of the individual light source 221. Other optical spatial modulators may be used instead of or in addition to the eletrowetting lens.

In the example of source 222, the source includes a number of light emitters EM located/oriented to output light in different angular directions. The source 222 also includes a corresponding number of TIR lenses 223, 225, 227, each coupled to receive light from a respective one of the light emitters EM. Each of the TIR-like lens structures 223, 225, and 227 directs light output from a respective one of the emitters EM with a predetermined beam shape and/or beam steering distribution. While shown as TIR-like lens structures, other beam steering/beam shaping techniques or structures may be used. Additional fixed optics (not shown) may be included. Although one or more controllable optical spatial modulators may be added to the source 222, the illustrated example does not include any additional controllable beam distribution elements. A degree of direction and output shape control is possible with the example of light source 222 by selectively operating one or more of the emitters EM.

In an operational example, a driver system, such as 113A (FIG. 3), is coupled to a processor 123A and the general illumination system 211 to control light generated by the general illumination system 211 and the image display by device 210. The processor 123A controls operation of the driver system 113A and has access to the memory 125A. The processor 123A executing programming in the memory, obtains an image selection and a predetermined general lighting selection (e.g. intensity and/or optical distribution) as software control data. The processor 123A and the driver system 113A cause the image display device 210 to present an image output based on the image selection. In addition, the processor 123A and the driver system 113A control operation of sources 221 or 222 of the general illumination system 211 via the driver system 113A to emit light for general illumination from the general illumination system 211 according to the general lighting selection.

In the examples of FIG. 4, the illumination system 211 may also implement a controllable spatial light distribution optical array for processing the emitted light according to the general lighting distribution selection. For example, the illumination system 211 may receive control signals from the driver system 113A that control beam steering/beam shaping type optical spatial modulator elements 231 of light sources 221 in an array, to each process light with a particular beam steering and/or beam shaping setting. As a result, the array of controlled sources 221 could provide a selected general lighting distribution.

Alternatively, in an example of the luminaire 200 implemented using light sources such as 222, the driving system 113A may provide control signals that individually turn ON specific individual light emitters EM within the various light sources 222 of an array forming the system 211. For example, when control signals provided by the driving system 113A only turn on the light source emitter EM that directs light through TIR lens 227, a source 222 provides a leftward angled light distribution (in the example orientation in FIG. 4). For another setting, control signals may turn on only the light source emitter EM that directs light through TIR lens 223 so that a source 222 provides a rightward angled light distribution (in the example orientation in FIG. 4). Still further control settings/signals could turn on various combinations of two emitters or a combination of all three emitters, within a particular source 222, to produce other combinatorial light output distributions from each light source 222 in an array of such sources forming general illumination system 211.

FIGS. 5A to 5E show various arrangements/orientations of the display device 210 and the illumination system 211 serving as the controllable general illumination light source(s) in luminaries similar to luminaire 200 of FIG. 4. Rather than incorporate beam distribution control in the illumination system (using sources like 221 or 223), as shown in the cross-sectional views of FIGS. 5A to 5C, each of the general illumination systems 211 is formed by a combination of a light source panel 211a and a spatial light distribution optical array 211b. Examples of the light source panel 211a and spatial light distribution optical array 211b are disclosed in more detail in the above incorporated-by-reference application Ser. No. 15/244,402 and 62/209,546. Each combination of a light source panel 211a and a spatial light distribution optical array 211b operates and is controlled essentially as described by way of example above and in the incorporated applications, to produce a distributed light output suitable for general illumination along one or more peripheral regions/edges of the display device 210.

Although the luminaire examples of FIGS. 5A to 5E may be suspended or otherwise mounted in various orientations, for convenience, the drawings show the luminaire examples with at least some light emitted directly downward, e.g. as if the luminaries were mounted on or at a distance below a ceiling (not shown). Also, some of the examples in these drawings may be mounted as pendants similar to FIGS. 1 to 2B, but other fixture mounting arrangements are possible. For example, at least some implementations of the luminaries of FIGS. 4 to 5E may be surface mounted on or recess mounted in a wall, ceiling or floor. Luminaires of these types also may be supported from below, for example, in a configuration as a table, floor or street lamp.

In the examples of FIGS. 5A and 5B, the image light and/or general illumination light from the display device 210 provides an image visible to a person within the space in which the lighting device 200 (FIG. 4) is installed. The intensity and/or color characteristics of the image and/or light output of the display device 210 may be selectively controlled, however, there is no direct spatial modulation of image light. Light, however, is additive. The light output of the general illumination system 211 is selectively spatially modulated. Hence, in an example like that shown in FIGS. 5A and 5B, the combination of light from the display device and light from the modulated distributed light outputs from the spatial modulation elements of the array 211b can be controlled to achieve a selected illumination lighting distribution, for example, to emulate a lighting distribution of a selected one of a variety of different luminaries known in the industry.

The light source panel 211a and spatial light distribution optical array 211b forming each genital illumination system 211 may be positioned at any desired angle relative to the output surface or aperture of the display device 201.

FIG. 5A, for example, illustrates an arrangement in which the light source panel 211a and spatial light distribution optical array 211b are mounted with their emission surfaces/apertures at an obtuse angle relative to the plane of the output surface or aperture of the display device 210. In such an arrangement, an observer looking at the fixture 200 would see a plan view (like FIG. 4) in which the spatial modulation elements 211b appear as additional emission sources along the edges of the display device 210.

As an alternative example, FIG. 5B illustrates an arrangement in which the light source panel 211a and spatial light distribution optical array 211b are mounted with their emission surfaces/apertures approximately in or parallel to the plane of the output surface or aperture of the display device 210. In such an arrangement, an observer looking at the fixture 200 would mainly see the output surfaces of the spatial modulation elements 211b along the edges of the display device 210 in a plan type view similar to FIG. 4, although we somewhat different visible dimensions of the output of the system 211 as compared to the angled arrangement of FIG. 5A.

FIGS. 5C and 5D are partial cross-sectional views in the vicinity of one corner (roughly along line A-A of FIG. 4) of a luminaire, similar to the views in FIGS. 5A and 5B. FIGS. 5C and 5D, however, show alternative configurations with some light output from each luminaire emitted in other example directions (e.g. some light emission upward in the illustrated orientations). In FIG. 5D, for example, the light for image display from device 210 is directed upwards. In such a case, the display device 210 may be a projector for projecting the image upwards onto a ceiling or the like. The illumination system 211 is shown at an obtuse angle similar to FIG. 5A, but could be arranged approximately horizontal alongside the display device 210 to provide a more vertical light output downward (albeit with the controlled illumination light output distribution.

In the example of FIG. 5D, the image display device is a flat panel display oriented for downward output of image light, similar to earlier examples of FIGS. 1 to 2B. The illumination system 211 in this FIG. 5D is shown in a location/orientation approximately horizontal alongside a periphery or edge of the display output surface; although the system 211 could be oriented at an angle extending somewhat above or below the horizontal, to achieve a desired angle of distributed illumination light output. In this example, the illumination light output from the illumination system 211 is directed generally upward (albeit with the controlled distribution) in a manner analogous to the upward illumination light output of the earlier examples in FIGS. 1 to 2B.

In yet another alternative example, FIG. 5E illustrates an arrangement in which the light source panel 211a and spatial light distribution optical array 211b are mounted with their emission surfaces/apertures approximately perpendicular to the plane of the output surface or aperture of the display device 210. In such an arrangement, an observer looking at the fixture 200 would mainly see the end surfaces of light source panel 211a and end surfaces of the spatial modulation elements 211b along the edges of the display device 210 in a plan type view similar to FIG. 4.

The general illumination system 211 may abut or adjoin the respective edge(s) along the periphery of the display device 210, as illustrated by way of examples in FIGS. 5A to 5D. For some general lighting applications, however, the general illumination system 211 may be separated somewhat from the respective edge(s) of the display device 210, as illustrated by way of example in FIG. 5E.

In the examples we have been considering so far, a processor, such as 123A, configures a particular lighting device 111A to provide light output from the display device 119A and to operate the luminaire 100 to provide general illumination. Any display and illumination settings may be selected. For example, a selected illumination configuration may substantially emulate a lighting distribution of a selected one of a number of types of luminaries known in the general lighting industry, e.g. that are available as fixed configuration luminaries. The display device 119A may present any selected image, for example, an image of a luminaire, an image of a sky, an image of selected art, etc.

As described herein, a software configurable lighting device 111A (e.g. FIG. 3) of the type described herein can store configuration information, e.g. defining intensity, color characteristic(s) and/or distribution, for one or more luminaire output settings. A user may define the parameters of a luminaire output setting in the lighting device 111A, for example, via a user interface on a controller or a user terminal (e.g. mobile device or computer) in communication with the software configurable lighting device 111A. In another example, the user may select or design a luminaire output setting via interaction with a server, e.g. of a virtual luminaire store; and the server communicates with the software configurable the lighting device 111A to download the configuration information for the selected/designed luminaire output setting into the lighting device 111A. When the software configurable lighting device 111A stores configuration information for a number of luminaire output settings, the user operates an appropriate interface to select amongst the luminaire settings available in the software configurable the lighting device 111A. Selections can be done individually by the user from time to time or in an automatic manner selected/controlled by the user, e.g. on a user's desired schedule or in response to user selected conditions such as amount of ambient light and/or number of occupants in an illuminated space.

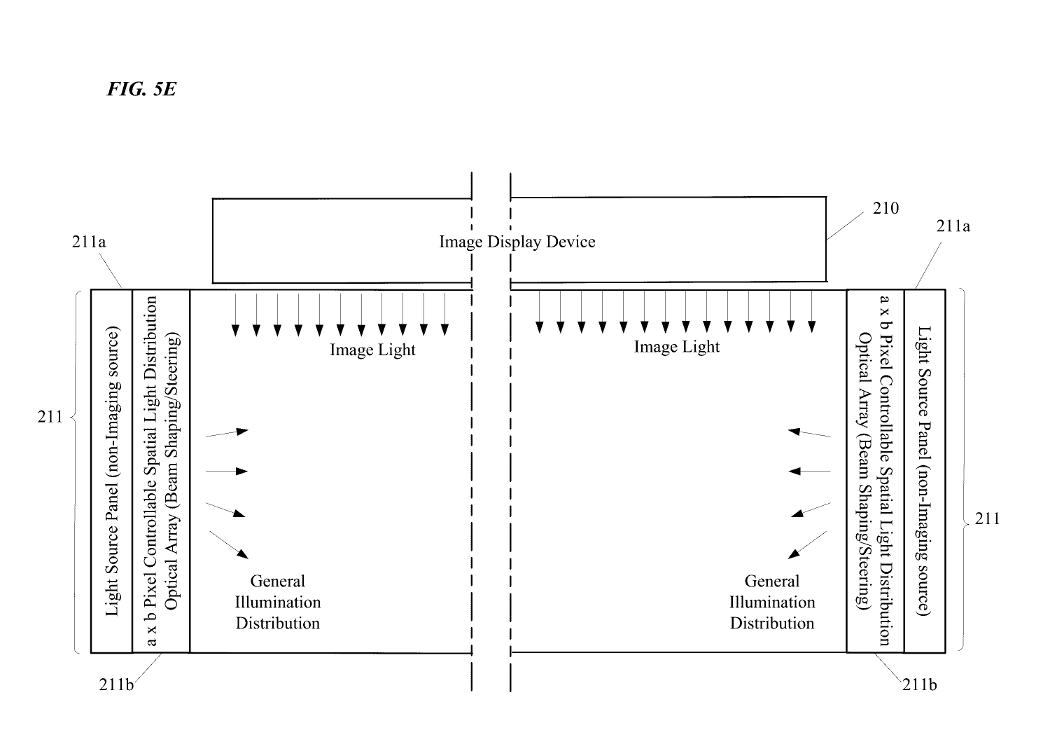

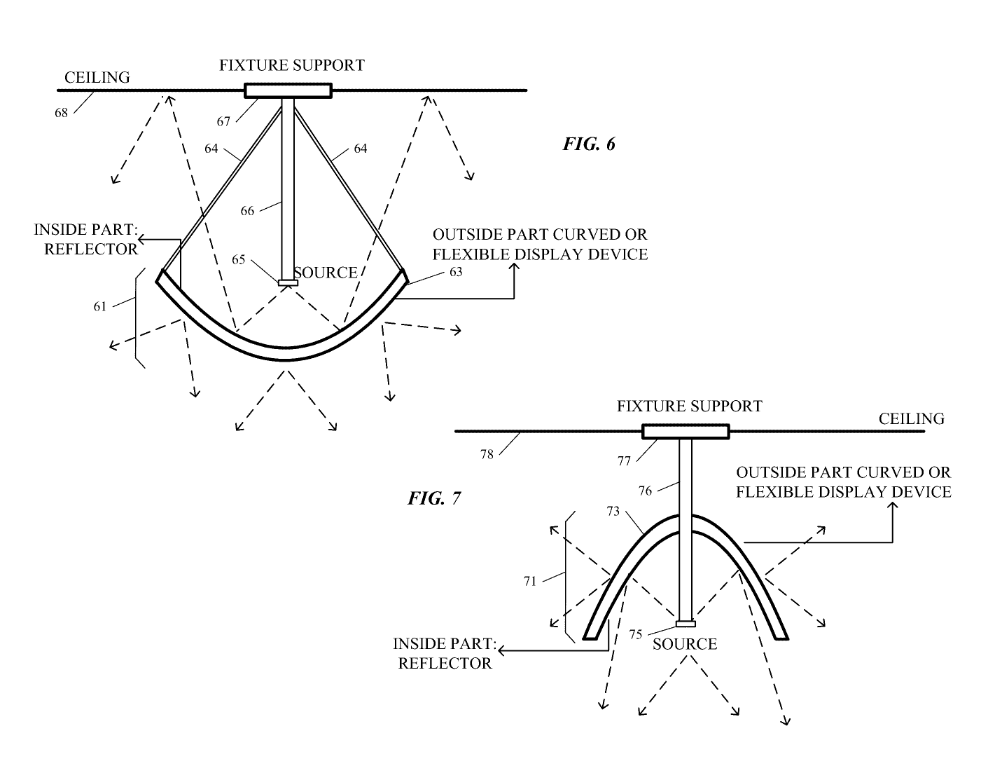

FIG. 6 illustrates a different example of a luminaire 61 that includes a display device 63 and an illumination light source 65, in which the display device 63 is curved. The illumination source 65 at least provides illumination light. If the source facing surface of the display 63 is partially reflective and partially transmissive with respect to the illumination light from the source 65, the illumination light source 65 may also supply at least some of the image light emitted by/through the display device. Initially, we will discuss an example of the luminaire 61 in which the outer curved surface of the display device 63 facing toward the source 65 is highly reflective, at least with respect to the visible illumination wavelengths of light from the source 65,

In the example of FIG. 6, the luminaire 61 is a suspended light fixture, e.g. a pendant light fixture. As in the earlier examples, the orientation of the luminaire 61 is shown by way of non-limiting example, and those skilled in the art should appreciate that the luminaire 61 may be mounted in other orientations for other types of lighting and display applications.

The luminaire 61 includes a curved display device 63, such as a curved panel display device similar to some modern television screen designs. Alternatively, the curved display device 63 may be implemented using a flexible display technology. For convenience, we will described device 63 as a curved display device, in the further discussion to follow. The degree of curvature of display device 63 shown in the drawing is for ease of illustration only and is not intended as a limiting or actual example of the degree of curvature of the display device. The display device 69 is configured to produce an image display output from a curved surface, in this example, from the downward facing portion of its curvature. In the orientation shown in the drawing, the curved display device 63 emits image display light in generally downward first directions (shown as downward dashed arrows) from pixel points along its curved lower/output surface.

The luminaire 61 also includes an illumination light source 65 co-located with the curved image display device 63 so that the display device 63 and the light source 65 are both elements of the luminaire 61. A variety of different types of light emitters may be used to implement the source 65. FIG. 6 is an end view of the luminaire showing edges of the curved display device 63 and the illumination light source 65. In this example, the illumination light source 65 is located below but approximately parallel to the longitudinal (perpendicular to the plane of the drawing) axis of curvature of the curved display device 63. Other locations in relation to that axis are feasible for one elongated source, and other locations not related to the axis may be suitable (e.g. if using multiple sources behind the display device 63. The single longitudinal light source 65, in an example like that shown, may be a fluorescent tube or the like or a string of LEDs mounted on a printed circuit board type strip.

In this example, the illumination light source 65 is supported by a strut 66 attached to a fixture support 67 at the ceiling 68. Brackets or the like on the light source 65 that provide an attachment point for the strut 66 are omitted for ease of illustration. The same support arrangement may extend and connect to the display device 65 to support the display device 65 at the appropriate height below the ceiling 68 and the illumination light source 65. In the illustration, however, the lighting device includes additional rods or cables 64, attached to the fixture support 67 at the ceiling 68, which extend connect to and support the display device. Brackets or the like on the display device 65 that provide one or more attachment points for the rods or cables 64 to the display device 63 are omitted for ease of illustration. A variety of different arrangements or structures may be used in place or the rods or cables 64, the strut 66 and the fixture support 67 to mount the components of the luminaire 61 at a desired height, in this example, below a location on the ceiling 68.

The outer surface of the display device, on the interior of the curvature of the display device 63, faces toward the illumination light source 65. That surface is reflective relative to the illumination light. A partially transmissive example is discussed later; and initially, we will discuss an implementation in which the reflective surface is highly reflective and not particularly transmissive. The reflective surface may be specular or diffusely reflective.

In this example, the illumination light source 65 is configured to at least emit illumination light toward the reflective surface of the curved display device 63. The reflective surface of the curved display device 63 directs (by reflection) illumination light emitted downward from the source 65 back upward toward the ceiling 68 (in the illustrated example of orientation), that is to say, in various second directions that are different from the directions of downward image light emission output from the curved display device 63. Although not shown by the dashed arrows, the illumination light source 65 may also emit some light upward toward the ceiling 68. Alternatively or in addition, the illumination light source 65 may be mounted sufficiently above the curved display device 63 to allow some passage of light to the sides above the lateral edges of the display device 63.

Although the light output from the illumination light source 65 may pass in other directions, in the illustrated example, the light source 65 emits at least a substantial portion of the illumination light output that is directed (by reflection) upwards towards the ceiling 68. Such an output from the illumination light source 65 is substantially opposite the directions (generally downward) of the image light output of curved display device 63. If the ceiling 68 is somewhat reflective, e.g. diffusely reflective white or pastel in color, much of the illumination light output from the light source 65 is further reflected down and distributed around the perimeter of the luminaire for indirect downward illumination.

The illumination light source 65 is configured to produce illumination light output, in this example, with industry acceptable performance for a general lighting application. For example, for task lighting, the source 65 may produce a white light that is reflected toward a diffusely reflective ceiling surface of intensity sufficient that the light further reflected downward from the ceiling 68 meets typical requirements for task lighting at a counter, desktop or floor level below the particular ceiling level.

The illumination light source 65 may be adjustable in various ways. For example, source 65 may be selectively controlled for dimming of the downlight intensity and/or to control the color characteristic of the emitted light and thus the light reflected downward from the ceiling 68. Also, the source structure and/or optical element(s) added to the source may enable selective control of the distribution (e.g. angle and/or shape) of the general illumination light output of the luminaire 61, as in earlier examples, such as the example of FIG. 3.

In this example, the configurable luminaire 61 provides a controllable downward display function. The display may output any still image or video, such as a still image of a sky or imagery of moving clouds in the sky or virtually any scene or video image desired by presentation in a particular space served by the luminaire 61.

The detailed discussion of the luminaire 61 to this point assumed that the reflective surface of the display device 63 reflected substantially all of the illumination light from the source 65. In such an arrangement, the curved display device 63 would include or connect to another light source (not separately shown) to generate light for the image display output. For example, the curved display device 63 might include a backlight or might generate light output at the pixels (e.g. form LEDs or OLEDs at the pixels).

It is also envisaged that the reflective surface of the curved display device 63 may be partially transmissive. In such a case, the reflective surface of the curved display device 63 would reflect sufficient light from the source 65 to support the illumination function of the luminaire 61. The partially transmissive surface of the curved display device 63, however, would also allow passage of sufficient light from the source 65 to backlight the display components of the device 63.

FIG. 7 illustrates another example of a luminaire 71 having a curved display device 73 and an illumination light source 75. A strut 76, attached to the fixture support 77, supports the light source 75. In this example, the strut 76 passes through the curved display device 73, although a bracket or the like may be proved at that point so that the strut also provides support for the display device 73.

In general, the elements forming the luminaire 71 may be similar to the elements forming the luminaire 61 of FIG. 6. As in the earlier examples, the orientation of the luminaire 71 is shown by way of non-limiting example, and those skilled in the art should appreciate that the luminaire 71 may be mounted in other orientations for other types of lighting and display applications. Luminaire 71, however, uses a different arrangement of the curved display device 73 and reflective surface relative to the illumination light source 75. In the example luminaire 71, the light source 75 emits a substantial amount of illumination light downward with fewer or no reflections.

As in the example of FIG. 6, the curved display device 73 may include a backlight, direct image light emitters or the like to generate the actual light for the image output, in which case the curved surface of the display device 73 facing toward the source 75 is highly reflective; or the curved surface of the display device 73 facing toward the source 75 may be partially transmissive and partially reflective so that some light from the source 75 passes through and backlights the controllable components of the display device 73. In either such implementation, the device 73 emits display light laterally and somewhat upwardly. Some illumination light from the source 75 is emitted downwardly, and some illumination light from the source 75 is reflected down by the reflective source-facing surface of the display device 73.

FIG. 8 illustrates an example 81 of a luminaire that uses a projector 83p and a display screen 83s to implement the image display device 83. As in the earlier examples, the orientation of the luminaire 81 is shown by way of non-limiting example, and those skilled in the art should appreciate that the luminaire 81 may be mounted in other orientations for other types of lighting and display applications.

In this example, the illumination light source 85 includes individual light emitters (and possibly associated optical elements) 85a to 85n similar to the source in the example of FIGS. 2 and 2A discussed earlier. Elements such as a strut, cables or rods, a fixture support in/on the ceiling and any appropriate brackets or other devices to provide attachment points to the illumination light source components 85a to 85n, the projector 83p and the display screen 83s may be implemented as discussed above relative to one or more of the earlier examples (and therefore are not numbered in FIG. 8). Although the drawing shows a single projector 83p, the luminaire 81 may include two or more such projectors.

In the luminaire 81, the projector 83p projects an image on the display screen 83s. The screen may be formed of a translucent material for rear projection type image display. Light of the image is visible on the display screen 83s. In the illustrated example of luminaire orientation, such image light is output in directions somewhat downward and outward from on the curvature of the display screen 83s.

Although the light output from the illumination light source 85 may pass in other directions, in the illustrated example, the light source 85 emits at least a substantial portion of the illumination light output that is directed upwards towards the ceiling. Such an output from the illumination light source 85 is substantially opposite the directions (generally downward) of the image light output through the curved display screen 83s. If the ceiling is somewhat reflective, e.g. diffusely reflective white or pastel in color, much of the illumination light output from the light source 85 is further reflected down and distributed around the perimeter of the luminaire 81 for indirect downward illumination.

The illumination light source 85 is configured to produce illumination light output, in this example, with industry acceptable performance for a general lighting application. For example, for task lighting, the source 85 may produce a white light that is reflected toward a diffusely reflective ceiling surface of intensity sufficient that the light further reflected downward from the ceiling meets typical requirements for task lighting at a counter, desktop or floor level below the particular ceiling level.

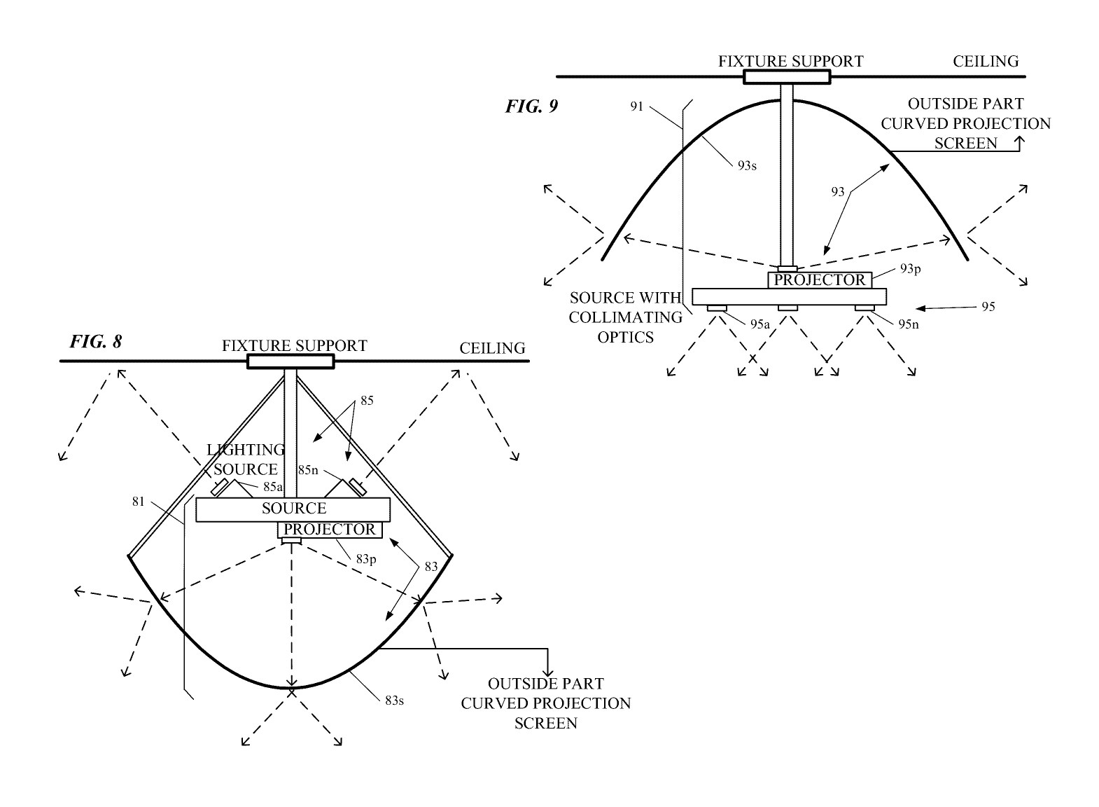

FIG. 9 illustrates a different example 91 of a luminaire, similar that of FIG. 8, but using a different arrangement of a projector 93p and a display screen 93s to implement the image display device 93. In this example, the illumination light source 95 includes individual light emitters 95a to 95n. The light emitters 95a to 95n may be separate groups of one or more LEDs, separate tubular lamps (e.g. fluorescent), or the like. Although not shown, for optical or aesthetic reasons, the luminaire 91 may include a diffuser or other optical processing component, through which illumination light from the emitters 95a to 95n passes, e.g. to improve distribution and/or reduce visible pixilation of the illumination light source 95. The light from the 95a to 95n forming the illumination light source 91, in this example, are emitted in downward directions in the illustrated orientation.

In the luminaire 91, the projector 93p projects light upward onto the display screen 93p. The screen may be formed of a translucent material for rear projection type image display. Light of the image is visible on the display screen 93s. In the illustrated example of luminaire orientation, such image light is output in directions somewhat laterally and upward from on the curvature of the display screen 93s.

As in the earlier examples, the orientation of the luminaire 91 is shown by way of non-limiting example, and those skilled in the art should appreciate that the luminaire 91 may be mounted in other orientations for other types of lighting and display applications.

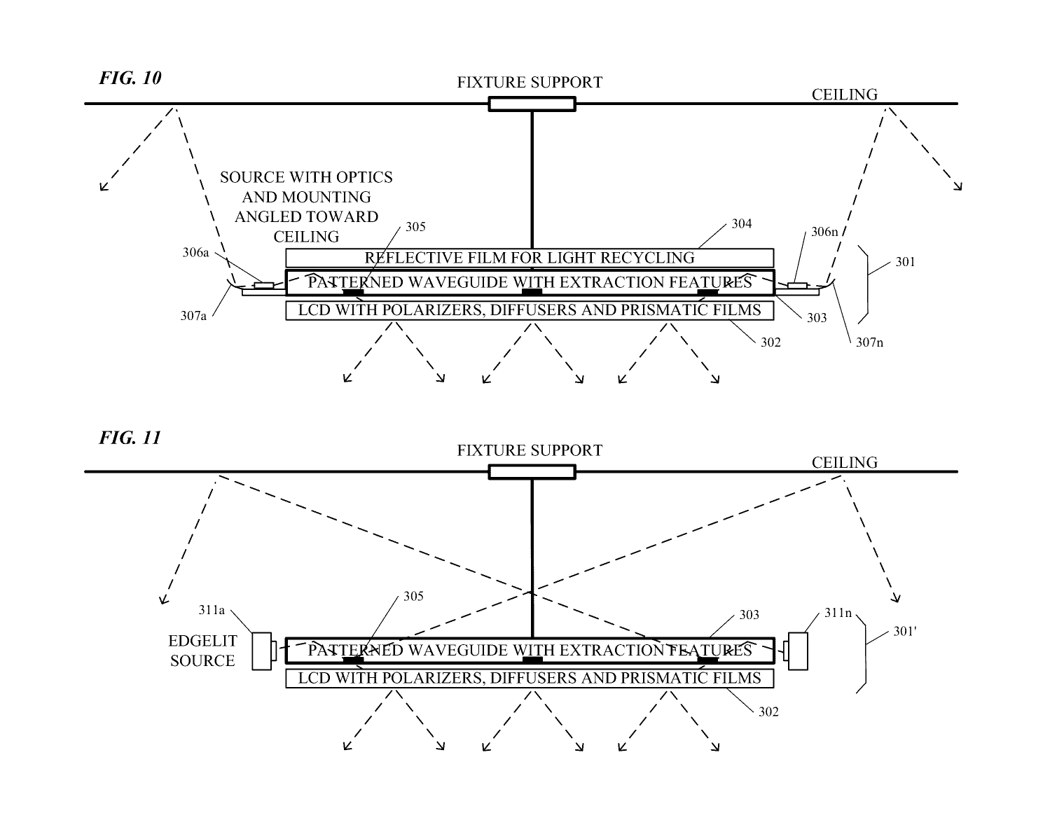

FIGS. 10 and 11 are end views of two different examples of luminaries that use a liquid crystal device (LCD) panel as the display device and a light waveguide for backlighting the LCD panel. The emitters forming the illumination light source also supply at least some light through the light waveguide for backlighting the LCD panel.

In FIG. 10, the luminaire 301 includes a display device 302 formed of a LCD panel. The luminaire 301 also includes a light waveguide 303 and a reflective film 304 on the surface of the light waveguide 304 opposite the LCD panel 302. Although not separately shown, the LCD panel 302 typically includes actual pixels of LCD color filters as well as other panel components, such as polarizers, diffusers and prismatic films, together forming a multi-layer stack. The reflective film 304 improves light recycling along the waveguide to improve optical efficiency. The waveguide 303 is patterned at the surface adjacent to the LCD panel 302 with a number of extraction features 305, to enable light emission from the surface of the waveguide toward the LCD panel 302.

The luminaire 301 also includes a light source formed by a number of emitters 306a to 306n and which may include associated reflectors 307a to 307n. The light source provides illumination light upward toward the ceiling as in a number of the earlier examples. In this example, the light emitters 306a to 306n of the source also provide light to the edges of the waveguide 303, for extraction as backlighting for the LCD panel 302 serving as the display device. However, because of the orientation and coupling arrangement of the emitters 306a to 306n, the light source in this example emits at least some light for general illumination that is not supplied or directed into an edge of the waveguide 303.

As in the earlier examples, the orientation of the luminaire 81 is shown by way of non-limiting example, and those skilled in the art should appreciate that the luminaire 81 may be mounted in other orientations for other types of lighting and display applications. The example shows a ceiling mounted arrangement with display downward and illumination light output upward for reflection off of and indirect downward illumination from the ceiling. Supporting elements such as a strut, cables or rods, a fixture support in/on the ceiling, a luminaire housing and any appropriate brackets or other devices to provide attachment points to the housing or to the illumination light source components, the LCD panel 302, the waveguide 303 and the reflective film 304 may be implemented as discussed above relative to one or more of the earlier examples (and therefore are not numbered in FIG. 10).

In FIG. 11, the luminaire 301′ includes the LCD panel 302 as the image display device, the light waveguide 303 including the pattern of extraction features 305. Mounting, orientation and display operation of the luminaire 301′ are general similar to those aspects regarding the earlier luminaire 301 example of FIG. 10. The luminaire 301′ however does not include the reflective film; and the emitters 311a to 311n that form the illumination light source are oriented to emit substantially all of the generated light into the edges of the waveguide 303. Rather than emitting some light for illumination upward directly from the emitters, the luminaire 301′ relies on upward emission of light from the waveguide 303 along the surface of the waveguide 303 opposite the LC panel 302, for the upward output of illumination light. The pattern of extraction features may be increased or modified to enhance the upward light output.

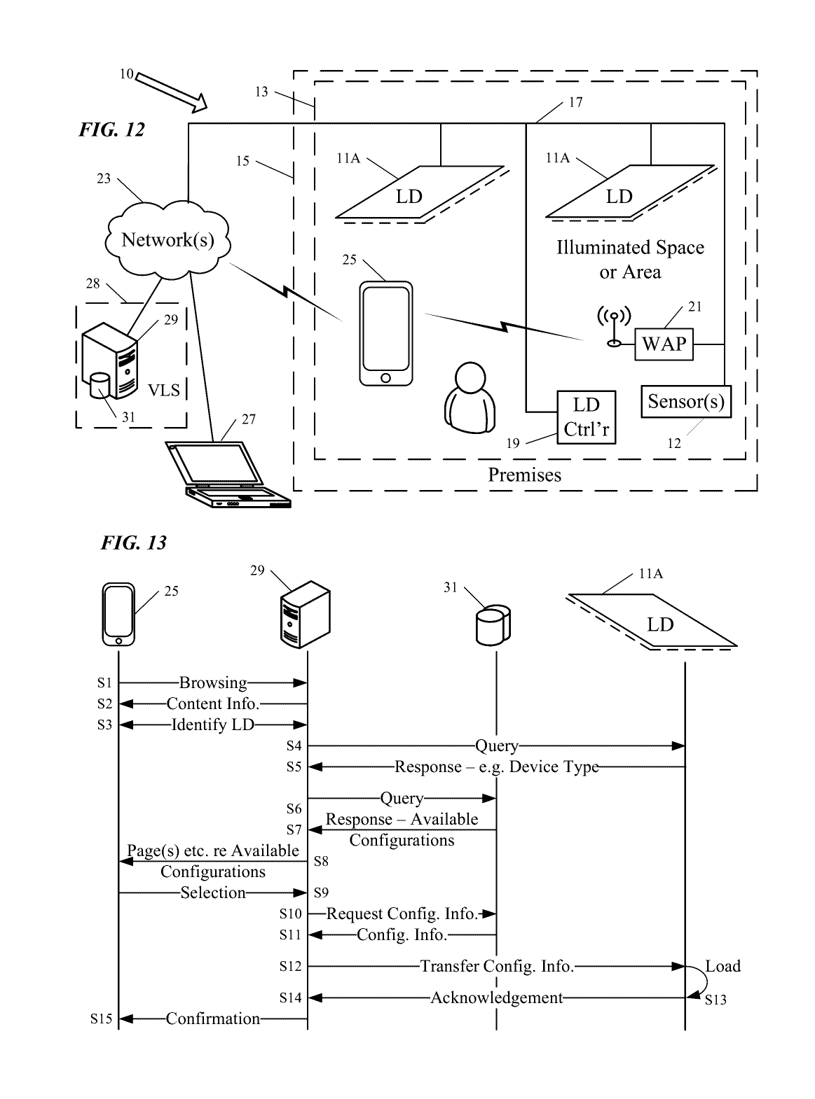

To provide examples of the methodologies and functionalities and associated software aspects of the technology, it may be helpful to consider a high-level example of a system including software configurable lighting devices 111A (FIG. 12), and later, an example of a possible process flow for obtaining and installing configuration information (FIG. 13).

FIG. 12 illustrates a lighting system 10 for providing configuration or setting information, e.g. based on a user selection, to at least one software configurable lighting device (LD) 111A of any of the types discussed herein. The system example 10 shown in the drawing includes a number of such lighting devices (LD) 111A. For purposes of discussion of FIG. 12, we will assume that software configurable lighting device 111A generally corresponds in structure to the block diagram illustration of a lighting device 111A in FIG. 3, with the illumination light source and display device structured/located to operate as a luminaire 1, 2 or 100 as discussed in various other examples above. The example of the lighting system 10 in FIG. 12 also includes a number of other devices or equipment configured and coupled for communication with at least one of the software configurable lighting devices 111A.

In the lighting system 10 FIG. 12, the software configurable lighting devices 111A, as well as some other elements of system 10, are installed within a space or area 13 to be illuminated at a premises 15. The premises 15 may be any location or locations serviced for lighting and other purposes by such system of the type described herein. Lighting devices, such as lighting devices 111A, that are installed to provide general illumination lighting in the premises 15 typically comply with governmental building codes (of the respective location of the premises 15) and/or lighting industry standards. Most of the examples discussed below focus on indoor building installations, for convenience, although the system may be readily adapted to outdoor lighting. Hence, the example of lighting system 10 provides configurable lighting and possibly other services in a number of service areas in or associated with a building, such as various rooms, hallways, corridors or storage areas of a building and an outdoor area associated with a building. Any building forming or at the premises 15, for example, may be an individual or multi-resident dwelling or may provide space for one or more enterprises and/or any combination of residential and enterprise facilities. A premises 15 may include any number of such buildings, and in a multi-building scenario the premises may include outdoor spaces and lighting in areas between and around the buildings, e.g. in a campus (academic or business) configuration.

The system elements, in a system like lighting system 10 of FIG. 12, may include any number of software configurable lighting devices 111A as well as one or more lighting controllers 19. Lighting controller 19 may be configured to provide control of lighting related operations (e.g., ON/OFF, intensity, brightness) of any one or more of the lighting devices 111A. Alternatively, or in addition, lighting controller 19 may be configured to provide control of the software configurable aspects of lighting device 111A. That is, lighting controller 19 may take the form of a switch, a dimmer, or a smart control panel including a graphical, speech-based and/or touch-based user interface, depending on the functions to be controlled through device 19. A lighting device may include a sensor. In the example, other system elements may also include one or more standalone implementations of sensors 12. Sensors, for example, may be used to control lighting functions in response to various detected conditions, such as occupancy or ambient light. Other examples of sensors include light or temperature feedback sensors that detect conditions of or produced by one or more of the lighting devices. If provided, the sensors may be implemented in intelligent standalone system elements such as shown at 12 in the drawing, or the sensors may be incorporated in one of the other system elements, such as one or more of the lighting devices 111A and/or the lighting controller 19.

The on-premises system elements 111A, 12, 19, in a system like system 10 of FIG. 12, are coupled to and communicate via a data network 17 at the premises 15. The data network 17 may be a wireless network, a cable network, a fiber network, a free-space optical network, etc.; although the example shows connection lines as may be used in a hard-wired or fiber type network implementation. The data network 17 in the example also includes a wireless access point (WAP) 21 to support communications of wireless equipment at the premises. For example, the WAP 21 and network 17 may enable a user terminal for a user to control operations of any lighting device 111A at the premises 13. Such a user terminal is depicted in FIG. 12, for example, as a mobile device 25 within premises 15, although any appropriate user terminal may be utilized. However, the ability to control operations of a lighting device 111A may not be limited to a user terminal accessing data network 17 via WAP 21 or other on-premises access to the network 17. Alternatively, or in addition, a user terminal such as laptop 27 located outside premises 15, for example, may provide the ability to control operations of one or more lighting devices 111A via one or more other networks 23 and the on-premises data network 17. Network(s) 23 may include, for example, a local area network (LAN), a metropolitan area network (MAN), a wide area network (WAN) or some other private or public network, such as the Internet.

Data network communications allow installation of configuration files into the lighting devices 111A at the premises and may allow selection among installed configuration files in any fixture that stores more than one such file. In another example, a memory device, such as a secure digital (SD) card or flash drive, containing configuration data may be connected to one or more of the on-premises system elements 111A, 12 or 19 in a system like system 10 of FIG. 12.

For lighting operations, the system elements (11A, 12 and/or 19) for a given service area are coupled together for network communication with each other through data communication media to form a portion of a physical data communication network. Similar elements in other service areas of the premises are coupled together for network communication with each other through data communication media to form one or more other portions of the physical data communication network at the premises 15. The various portions of the network in the service areas in turn are coupled together to form a data communication network at the premises, for example to form a LAN or the like, as generally represented by network 17 in FIG. 12. Such data communication media may be wired and/or wireless, e.g. cable or fiber Ethernet, Wi-Fi, Bluetooth, or cellular short range mesh. In many installations, there may be one overall data communication network 17 at the premises. However, for larger premises and/or premises that may actually encompass somewhat separate physical locations, the premises-wide network 17 may actually be built of somewhat separate but interconnected physical networks utilizing similar or different data communication media.

System 10 also includes server 29 and database 31 accessible to a processor of server 29. Although FIG. 12 depicts server 29 as located outside premises 15 and accessible via network(s) 23, this is only for simplicity and no such requirement exists. Alternatively, server 29 may be located within premises 15 and accessible via network 17. In still another alternative example, server 29 may be located within any one or more system element(s), such as lighting device 111A, lighting controller 19 or sensor 12. Similarly, although FIG. 12 depicts database 31 as physically proximate server 29, this is only for simplicity and no such requirement exists. Instead, database 31 may be located physically disparate or otherwise separated from server 29 and logically accessible by server 29, for example via network 17.

Database 31 is a collection of configuration information files for use in conjunction with one or more of software configurable lighting devices 111A in premises 15 and/or similar devices 111A of the same or other users at other premises. The image and lighting configuration may be combined into one configuration file for each overall luminaire output performance configuration or setting, or each image and each set of light configuration information may be in separate configuration files. For general illumination lighting, a setting or configuration file may specify intensity performance at various dimming levels and/or one or more color characteristics; and such configuration information may include distribution settings for a lighting device luminaire 100 that incorporates spatial optical modulation capabilities for the illumination light output.

The software configurable lighting device 111A is configured to set light generation parameters of the light source and possibly set modulation parameters for any spatial modulator in accordance with a selected configuration information file. That is, a selected configuration information file from the database 31 may enable a software configurable lighting device 111A to achieve a performance corresponding to a selected type or of existing hardware luminaire for a general illumination application or any other arbitrarily designed/selected performance. Thus, the combination of server 29 and database 31 may represent a “virtual luminaire store” (VLS) 28 or a repository of available configurations that enable a software configurable lighting device 111A to selectively function like any one of a number of real or imagined luminaries represented by the available illumination configurations.

It should be noted that the output performance parameters need not always or precisely correspond optically to the emulated luminaire. For a catalog luminaire selection example, the light output parameters may represent those of one physical luminaire selected for its light characteristics whereas the distribution performance parameters may be those of a different physical luminaire or even an independently determined performance intended to achieve a desired illumination effect in area 13. The light distribution performance, for example, may conform to or approximate that of a physical luminaire or may be an artificial construct for a luminaire not ever built or offered for sale in the real world.

It should also be noted that, while various examples describe loading a single configuration information file onto a software configurable lighting device 111A, this is only for simplicity. Lighting device 111A may receive one, two or more configuration information files and each received file may be stored within lighting device 111A. In such a situation, a software configurable lighting device 111A may, at various times, operate in accordance with configuration information in any selected one of multiple stored files, e.g. operate in accordance with first configuration information during daylight hours and in accordance with second configuration information during nighttime hours or in accordance with different file selections from a user operator at different times. Alternatively, a software configurable lighting device 111A may only store a single configuration information file. In this single file alternative situation, the software configurable lighting device 111A may still operate in accordance with various different configuration information, but only after receipt of a corresponding configuration information file which replaces any previously received file(s).

An example of an overall methodology will be described later with respect to FIG. 13. Different components in a system 10 like that of FIG. 12 will implement methods with or portions of the overall methodology, albeit from somewhat different perspectives. It may be helpful at this point to discuss, at a high level, how various elements of system 10 interact to allow a lighting designer or other user to select a particular image and performance parameters to be sent to software configurable lighting device 111A implementing a luminaire 100 of the type described herein.

In one example, the user utilizes mobile device 25 or laptop 27 to access virtual luminaire store 28 provided on/by server 29 and database 31. Although the examples reference mobile device 25/laptop 27, this is only for simplicity and such access may be via LD controller 19 or any other appropriate user terminal device. Virtual luminaire store 28 provides, for example, a list or other indication of physical or virtual luminaries that may be emulated either by software configurable lighting devices 111A generally and/or by a particular software configurable lighting device 111A. Virtual luminaire store 28 also provides, for example, a list or other indication of potential performance parameters under which software configurable lighting devices generally and/or lighting device 111A particularly may operate. Alternatively, or in addition, virtual luminaire store 28 may allow the user to provide a customized light performance parameters and/or optical spatial modulation as part of the browsing/selection process. As part of the browsing/selection process, the user, for example, may identify the particular software configurable lighting device 111A or otherwise indicate a particular type of software configurable lighting device for which a subsequent selection relates. In turn, virtual luminaire store 28, for example, may limit what is provided to the user device (e.g., the user is only presented with performance parameters for luminaire emulations supportable by to the particular software configurable lighting device 111A). The user, as part of the browsing/selection process, selects desired performance parameters to be sent to a particular software configurable lighting device 111A. Based on the user selection, server 29 transmits a configuration information file containing configuration information corresponding to the selected parameters to the particular software configurable lighting device 111A.

It may also be helpful to discuss, at a high level, how a software configurable lighting device 111A interacts with other elements of system 10 to receive a file containing configuration information and how the software configurable lighting device 111A utilizes the received file to operate in accordance with performance parameters specified by the lighting device configuration information from the file. In a method example from the device-centric perspective, the software configurable lighting device 111A receives a configuration information file via network 17, such as the configuration information file transmitted by server 29 in the previous example. The received configuration information file includes, for example, data to set the light output parameters of software configurable lighting device 111A with respect to lighting parameters with respect to light intensity, light color characteristic of the like and possibly with respect to optical spatial modulation. The same or a separate file may provide an image (still or video) for the display output. Lighting device 111A stores the received configuration file, e.g. in a memory of lighting device 111A. In this further example, the software configurable lighting device 111A sets light output parameters in accordance with the data included in the configuration information file and may control the output display based on received image data. In this way, lighting device 111A stores the received file(s) and can utilize configuration information contained in the file control the illumination light output performance and display output of the software configurable lighting device 111A.

The lighting device configuration information in a configuration file may correspond to performance of an actual physical luminaire, e.g. so that the software configurable lighting device 111A presents an illumination output for a general lighting application having a distribution and possibly light characteristics (e.g. intensity and color characteristic) approximating those of a particular physical lighting device of one manufacturer. The on-line store implemented by server 29 and database 31 in the example of FIGS. 12 and 13 therefore would present content showing and/or describing a virtual luminaire approximating the performance of the physical lighting device. In that regard, the store may operate much like the manufacturer's on-line catalog for regular lighting devices allowing the user to browse through a catalog of virtual luminaire performance characteristics, many of which represent corresponding physical devices. However, virtual luminaire store 28 may similarly offer content about and ultimately deliver information defining the visible performances of other virtual luminaries, e.g. physical lighting devices of different manufacturers, or of lighting devices not actually available as physical hardware products, or even performance capabilities that do not emulate otherwise conventional lighting devices.

Virtual luminaire store 28 allows a lighting designer or other user to select from any such available luminaire performance for a particular luminaire application of interest. Virtual luminaire store 28 may also offer interactive on-line tools to customize any available luminaire performance and/or interactive on-line tools to build an entirely new luminaire performance for implementation via a software configurable lighting device 111A.

The preceding examples focused on selection of one set of lighting device configuration information, for the luminaire performance characteristics. Similar procedures via virtual luminaire store 28 will enable selection and installation of one or more additional sets of lighting device configuration information, e.g. for use at different times or for user selection at the premises (when the space is used in different ways). Display images may be selected through the store 28 or obtained from other image sources.

FIG. 13 is a Ping-Pong chart type signal flow diagram, of an example of a procedure for loading lighting device configuration information to a software configurable lighting device 111A, in a system like that of FIG. 12. In an initial step S1, a user browses virtual luminaire store 28. For example, a user utilizes mobile device 25 to access server 29 and reviews various luminaries or luminaire performances available in the virtual luminaire store 28, as represented by configuration information files. Although the mobile device 25 is referenced for simplicity in some examples, such access may be achieved by the user via laptop 27, LD controller 19 or other user terminal device. If the device 111A has appropriate user input sensing capability, access to store 28 may alternatively use device 111A. In step S2, virtual luminaire store 28 presents information about available virtual luminaries to the user. The content supplied to the mobile device or other user interface equipment may be any suitable format of multimedia information about the virtual luminaries and the performance characteristics, e.g., text, image, video or audio. While steps S1 and S2 are depicted as individual steps in FIG. 13, no such requirement exists and this is only for simplicity. Alternatively, or in addition, steps S1 and S2 may involve an iterative process wherein the user browses a series of categories and/or sub-categories and virtual luminaire store 28 provides the content of each category and/or sub-category to the user. That is, steps S1 and S2 represent the ability of a user to review data about some number of virtual luminaries available in virtual luminaire store 28 for configuring a software configurable lighting device.

In step S3, the user identifies a particular software configurable lighting device 111A for which a selected configuration information file is to be provided. For example, if the space or area 13 to be illuminated is the user's office, the user identifies one of several lighting devices 111A located in the ceiling or on a wall of that office. In step S4, server 29 queries the particular lighting device 111A through the network(s) to determine a device type, and the particular lighting device 111A responds with the corresponding device type identification.

In one example, software configurable lighting devices 111A include three different types of lighting devices. Each different lighting device, for example, utilizes a different type of illumination light general source and/or a different spatial distribution system. Each different lighting device therefore may have a different type of driver system. In such an overall example, each of the three different types of lighting devices 111A may only be configured to provide performance for some number of available virtual luminaire performance characteristics (e.g., different virtual luminaire output light parameters, such as intensity and color characteristics and possibly different virtual luminaire output distributions). In a three-device-type example, assume device type one supports X sets of virtual luminaire performance characteristics, device type two supports Y sets of virtual luminaire performance characteristics and device type three supports Z sets of virtual luminaire performance characteristics. Thus, in this example, server 29 queries lighting device 111A in step S4 and lighting device 111A, in step S5, responds with device type one, for example.

In step S6, server 29 queries database 31 to identify available sets of virtual luminaire performance characteristics supported by the particular lighting device 111A. Such query includes, for example, the device type of the particular lighting device 111A. In step S7, the database responds with available sets of virtual luminaire performance characteristics supported by the particular lighting device 111A. For example, if particular lighting device 111A is of device type one, then database 31, in step S7, responds with device type one available sets of virtual luminaire performance characteristics. In step S8, server 29 provides corresponding information to the user about those available sets of virtual luminaire performance characteristics supported by particular lighting device 111A.

Thus, steps S3-S8 allow a user to be presented with information about performance parameter sets for only those virtual luminaries supported by the particular type of software configurable lighting device 111A that the user is attempting to configure. However, these steps are not the only way for identifying only those sets of virtual luminaire performance characteristics supported by a particular lighting device. In an alternate example, the user may identify the device type as part of step S3 and server 29 may proceed directly to step S6 without performing steps S4-S5.

In still another example, the user may identify the particular software configurable lighting device 111A, either with or without a device type, in an initial step (e.g., perform step S3 before step S1). In this way, steps S1 and S2 only include information about performance parameter sets for those available virtual luminaries supported by the identified lighting device 111A; and step S8 need not be performed as a separate step. In other words, steps S1-S8 represent only one example of how information describing available virtual luminaries in virtual luminaire store 28 are presented to a user for subsequent selection.

The user, in step S9, utilizes mobile device 25 to select information about a performance parameter set for a desired virtual luminaire lighting application from among the available virtual luminaire performance characteristics previously presented. For example, if the user desires a luminaire performance from device 111A analogous to performance of a particular can light with downlighting, and the performance for the desired can downlight is supported by lighting device 111A, the user selects the virtual luminaire performance characteristics for the desired can downlight in step S9.

While the descriptions of various examples most commonly refer to information about a single virtual luminaire or selection of information about a single virtual luminaire, this is only for simplicity. The virtual luminaire store 28 described herein allows a user to separately select each of the image to be displayed by a software configurable lighting device and the set of performance parameters to control illumination produced by that software configurable lighting device 111A. As such, although not explicitly depicted in FIG. 13 or described above in relation to steps S1-S9, the user, for example, may select some of the performance characteristics for a desired first virtual luminaire lighting application corresponding to one type of luminaire, e.g. intensity and light color characteristics and select other performance parameters corresponding to a different virtual luminaire, e.g. shape and/or steering for beam light output distribution, as part of step S9. Alternatively, or in addition, the virtual luminaire store 28 may also allow the user to define or otherwise customize the set of performance parameters to be delivered to the software configurable lighting device 111A. The user also can select one or more images for display while the software configurable lighting device 111A is operating in accordance with a selected set of general illumination performance parameters.

In step S10, server 29 requests the corresponding information about the selected set of performance parameters from database 31 in order to obtain a corresponding configuration information file. One or more images may also be selected, if the store 28 will be the source of the image to be displayed via the combinatorial luminaire 100. Database 31, in step S11A, provides the requested information to server 29. As noted previously, a software configurable lighting device 111A may be one particular type of multiple different types of software configurable lighting devices usable in systems such as 10 and supported by the virtual luminaire store 28. The selected configuration information may be different for each different type of software configurable lighting device (e.g., a first type device 111A may support a first set of illumination performance parameters (intensity and/or color characteristics) while a second type device 111A may support a second set of illumination performance parameters; and/or a first type device 111A may support light output distribution of one format while a second type device 111A may not support the same light output distribution format). In one example, database 31 maintains different configuration information corresponding to each different type of software configurable lighting device 111A; and, as part of step S11A, database 31 provides the appropriate corresponding configuration information. Alternatively, database 31 maintains common or otherwise standardized configuration information; and, after receiving the requested configuration information from database 31, server 29 may manipulate or otherwise process the received configuration information in order to obtain a configuration information file more specifically corresponding to the type of the particular lighting device 111A intended to currently receive the configuration information. In this way, server 29 obtains a file of suitable configuration information including information about the selected set of performance parameters.

Server 29, in step S12, transfers the configuration information file to the particular software configurable lighting device 111A. For example, the server 29 utilizes network(s) 23 and/or network 17 to communicate the configuration information file directly to the software configurable lighting device 111A. Alternatively, or in addition, the server 29 may deliver the configuration information file to a user terminal (e.g., mobile device 25 or laptop 27) and the user terminal may, in turn, deliver the file to the software configurable lighting device 111A. In still another example, the server 29 transfers the configuration information file to LD controller 19 which, in turn, uploads or otherwise shares the configuration information file with the software configurable lighting device 111A. Selected images may be included in the downloaded configuration information file, or similar communication techniques may be used separately to transfer one or more selected images for installation in the software configurable lighting device 111A.

In step S13, the software configurable lighting device 111A receives the configuration information file and any separate image files and stores the received file(s) in memory, e.g. in the storage/memory 125 in the example device 111A of FIG. 3. Once lighting device 111A has successfully received and stored the selected configuration information file and any image data, the software configurable lighting device 111A provides an acknowledgement to server 29 in step S14. In turn, server 29 provides a confirmation of the transfer to the user via mobile device 25 in step S15. In this way, a user is able to select a desired virtual luminaire performance and any desired image from a virtual luminaire store and have the corresponding file/image(s) delivered to the identified lighting device 111A.

While the discussion of FIG. 13 focused on delivering a single configuration information file to a single software configurable lighting device 111A, this is only for simplicity. The resulting configuration information file may be delivered to one or more additional lighting devices 111A in order to implement the same configuration on the additional lighting devices. A selected image may be similarly delivered to any number of lighting devices 111A. For example, a user may elect to have steps S13-S15 repeated some number of times for a corresponding number of additional software configurable lighting devices. Alternatively, or in addition, the various steps of FIG. 13 may be repeated such that different configuration information files are delivered to different software configurable lighting devices 111A. As such, a single configuration information file may be delivered to some number of software configurable lighting devices while a different configuration information file is delivered to a different number of lighting devices and still another configuration information file is delivered to yet a further number of lighting devices. In this way, the virtual luminaire store 28 represents a repository of sets of virtual luminaire performance characteristics which may be selectively delivered to utilized by one or more software configurable lighting devices 111A.

Other aspects of the virtual luminaire store not shown may include accounting, billing and payment collection. For example, virtual luminaire store 28 may maintain records related to the type and/or number of configuration information files transmitted to software configurable lighting devices 111A at different premises 15 and/or owned or operated by different customers. Such records may include a count and/or identifications of different lighting devices receiving configuration information files or images, a count of how many times the same lighting device receives the same or a different configuration information file or images, a count of times each set of virtual luminaire performance characteristics is selected, a count of times each image is selected, as well as various other counts or other information related to selection and delivery of configuration information files and/or images. In this way, virtual luminaire store 28 may provide an accounting of how the store is being utilized.

In a further example, a value is associated with each configuration information file or each component included within the file (e.g., a value associated with each set of spatial modulation or distribution type performance parameters and/or a value associated with each set of light output performance parameters). Value could similarly be associated with each image available for selection and downloading. The associated value may be the same for all configuration information files (or for each included component), or the associated value may differ for each configuration information file (or for each included component). Value may be equal among images or vary based on some criteria, e.g. age or popularity. While such associated value may be monetary in nature, the associated value may alternatively represent non-monetary compensation. In this further example, virtual luminaire store 28 is able to bill for each transmitted image or configuration information file (or each included component); and the operator of the store can collect payment based on a billed amount. In conjunction with the accounting described above, such billing and payment collection may also vary based on historical information (e.g., volume discount, reduced value for subsequent transmission of the same configuration information file to a different lighting device, free subsequent transmission of the same configuration information file or image to the same lighting device, etc.). In this way, virtual luminaire store 28 may allow an individual or organization operating the store to capitalize on the resources contained within the store.

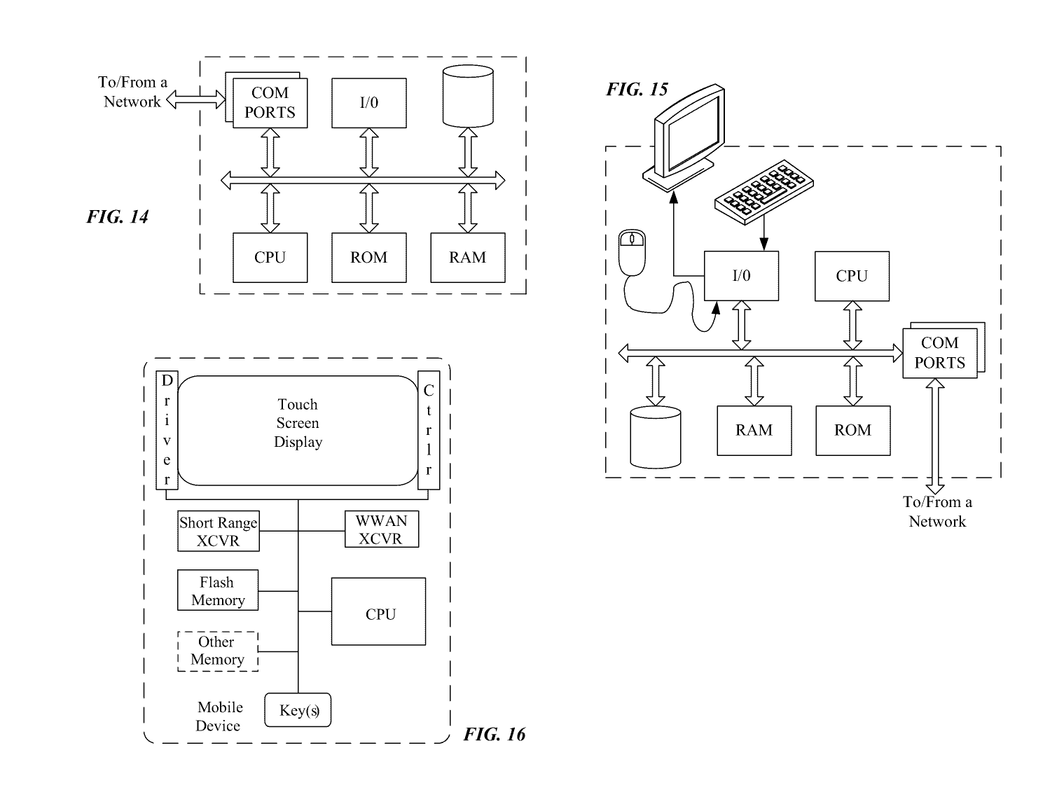

As shown by the above discussion, although many intelligent processing functions are implemented in lighting device, at least some functions may be implemented via communication with general purpose computers or other general purpose user terminal devices, although special purpose devices may be used. FIGS. 14-16 provide functional block diagram illustrations of exemplary general purpose hardware platforms.

FIG. 14 illustrates a network or host computer platform, as may typically be used to generate and/or receive lighting device 111A control commands, configuration files and/or images and to access networks and devices external to the lighting device 111A, for example, to implement the server 29 and/or the database 31 of the virtual luminaire store 28 of FIGS. 12 and 13. FIG. 15 depicts a computer with user interface communication elements, such as terminal 27A as shown in FIG. 12, although the computer of FIG. 15 may also act as a server if appropriately programmed. The block diagram of a hardware platform of FIG. 16 represents an example of a mobile device, such as a tablet computer, smartphone or the like with a network interface to a wireless link, which may alternatively serve as a user terminal device for providing a user communication with a lighting device, such as 111A, or with a server. It is believed that those skilled in the art are familiar with the structure, programming and general operation of such computer equipment and as a result the drawings should be self-explanatory.

A server (see e.g. FIG. 14), for example, includes a data communication interface for packet data communication via the particular type of available network. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load. A server, such as that shown in FIG. 14, may be accessible or have access to a lighting device 111A via the communication interfaces 117A of the lighting device 111A. For example, the server may deliver respond to a user request or an image and/or a configuration information file to send the requested information to a communication interface 117A of the lighting device 111A. The information of a configuration information file may be used to configure a software configurable lighting device, such as lighting device 111A, to set light output parameters comprising: (1) light intensity, (2) light color characteristic, (3) spatial modulation, or (4) image display in accordance with the received information.

A computer type user terminal device, such as a desktop or laptop type personal computer (PC), similarly includes a data communication interface CPU, main memory (such as a random access memory (RAM)) and one or more disc drives or other mass storage devices for storing user data and the various executable programs (see FIG. 15). A mobile device (see FIG. 16) type user terminal may include similar elements, but will typically use smaller components that also require less power, to facilitate implementation in a portable form factor. The example of FIG. 16 includes a wireless wide area network (WWAN) transceiver (XCVR) such as a 3G or 4G cellular network transceiver as well as a short range wireless transceiver such as a Bluetooth and/or WiFi transceiver for wireless local area network (WLAN) communication. The computer hardware platform of FIG. 14 and the terminal computer platform of FIG. 15 are shown by way of example as using a RAM type main memory and a hard disk drive for mass storage of data and programming, whereas the mobile device of FIG. 16 includes a flash memory and may include other miniature memory devices. It may be noted, however, that more modern computer architectures, particularly for portable usage, are equipped with semiconductor memory only.

The various types of user terminal devices will also include various user input and output elements. A computer, for example, may include a keyboard and a cursor control/selection device such as a mouse, trackball, joystick or touchpad; and a display for visual outputs (see FIG. 15). The mobile device example in FIG. 16 uses a touchscreen type display, where the display is controlled by a display driver, and user touching of the screen is detected by a touch sense controller (Ctrlr). The hardware elements, operating systems and programming languages of such computer and/or mobile user terminal devices also are conventional in nature, and it is presumed that those skilled in the art are adequately familiar therewith.

The user device of FIG. 15 and the mobile device of FIG. 16 may also interact with the lighting device 111A in order to enhance the user experience. For example, third party applications stored as programs 127A may correspond to control parameters of a software configurable lighting device, such as image display and general illumination lighting distribution that are selectable via the mobile device or other user terminal.

The lighting device 111A in other examples is configured to perform visual light communication. Because of the beam steering (or steering) capability, the data speed and bandwidth can have an increased range. For example, beam steering and shaping provides the capability to increase the signal-to-noise ratio (SNR), which improves the visual light communication (VLC). Since the visible light is the carrier of the information, the amount of data and the distance the information may be sent may be increased by focusing the light. Beam steering allows directional control of light and that allows for concentrated power, which can be a requirement for providing highly concentrated light to a sensor. In other examples, the lighting device 111A is configured with programming that enables the lighting device 111A to “learn” behavior. For example, based on prior interactions with the platform, the lighting device 111A will be able to use artificial intelligence algorithms stored in memory 125A to predict future user behavior with respect to a space.

As also outlined above, aspects of the techniques form operation of a software configurable lighting device with the combinatorial luminaire and any system interaction therewith, may involve some programming, e.g. programming of the lighting device or any server or terminal device in communication with the lighting device. For example, the mobile device of FIG. 16 and the user device of FIG. 15 may interact with a server, such as the server of FIG. 14, to obtain a configuration information file that may be delivered to a software configurable lighting device 111A. Subsequently, the mobile device of FIG. 16 and/or the user device of FIG. 15 may execute programming that permits the respective devices to interact with the software configurable lighting device 111A to provide control commands such as the ON/OFF command or a performance command, such as dim or change beam steering angle or beam shape focus. The processor 123A of the software configurable lighting device 111A in turn runs its programming 127A to control the display device and the light source of the luminaire 100, in according with one or more received images and in accordance with received light performance settings from a configuration information file.

Program aspects of the technology discussed above therefore may be thought of as “products” or “articles of manufacture” typically in the form of executable code and/or associated data (software or firmware) that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software or firmware programming. All or portions of the programming may at times be communicated through the Internet or various other telecommunication networks. Such communications, for example, may enable loading of the software from one computer or processor into another, for example, from a management server or host computer of the lighting system service provider into any of the lighting devices, sensors, user interface devices, other non-lighting-system devices, etc. Thus, another type of media that may bear the software/firmware program elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible or “storage” media, terms such as computer or machine “readable medium” refer to any medium that participates in providing instructions to a processor for execution.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A luminaire, comprising:
a display device configured to produce an image display output in a first direction; and
a light source co-located with the display device so that the display device and the light source are both elements of the luminaire,
the light source being configured to produce an illumination light output, wherein the illumination light is output in or directed into a second direction different from the first direction.

2. The luminaire of claim 1, wherein the light source is configured to produce the illumination light output, in the second direction, with an industry acceptable performance for a general lighting application.

3. The luminaire of claim 1, further comprising at least one bracket coupled to support the luminaire including both the display device the light source, each bracket configured to provide an attachment point for a support enabling mounting of the luminaire below a ceiling.

4. The luminaire of claim 3, wherein the display device and the light source are configured in the luminaire such that the first direction is downward and the second is upward toward the ceiling.

5. The luminaire of claim 4, wherein the display device and the light source are configured in the luminaire such that first direction is upward toward the ceiling and the second direction is downward.

6. The luminaire of claim 1, further comprising a controllable spatial optical modulator coupled to receive and process light from the illumination source, and configured to selectively control angle or shape of the illumination light output in or directed into the second direction.

7. The luminaire of claim 6, wherein the controllable spatial optical modulator comprises an array of individually controllable spatial light modulation elements.

8. The luminaire of claim 1, wherein the display device comprises a flat or curved panel display device.

9. The luminaire of claim 8, wherein the illumination light source and the flat or curved panel display device are configured so that the light source supplies light to the flat or curved panel display device so that the display device outputs display light using light from the illumination light source.

10. The luminaire of claim 1, wherein the display device comprises a projector.

11. The luminaire of claim 10, wherein the display device further comprises a display screen for receiving a projection of the image from the projected.

12. The luminaire of claim 1, wherein the display device comprises one or more light emitting components located along a portion of a periphery of the display device.

13. The luminaire of claim 1, wherein the light source comprises:
a liquid crystal device panel; and
a light waveguide having a light emitting surface coupled to backlight the liquid crystal device panel,
wherein the light source emits at least some light into an edge of the waveguide.

14. The luminaire of claim 13, further comprising:
a reflective film on a surface of the waveguide opposite the waveguide surface coupled to backlight the liquid crystal device panel,
wherein the light source also emits at least some light for general illumination, not into the edge of the waveguide.

15. The luminaire of claim 13, wherein a surface of the waveguide opposite the waveguide surface coupled to backlight the liquid crystal device panel passes some light received from the source into the second direction.

16. A lighting device including the luminaire of claim 1 and further comprising:
a driver system configured to operate the display device and the light source; and
a processor coupled to control the display device and the light source through the driver system.

17. The lighting device of claim 16, wherein the driver system comprises:
a display driver configured to controllably provide signals to the display device to cause the display device to present a selected image via the image display output; and
a light source driver configured to controllably provide a signal to operate the light source.

18. The lighting device of claim 16, further comprising:
a communication interface accessible by the processor and coupled to enable the processor to communicate via a data communication network,
wherein the processor is configured to receive data for use in controlling the driver system to select the image for presentation via the image display output and to select at least one controllable light parameter of the illumination light output produced by the light source.

19. A lighting system comprising the lighting device of claim 18 and a lighting controller, wherein the communication interface provides data communication between amongst the lighting device and the lighting controller over links of the data network.

20. A lighting system comprising a plurality of lighting devices according to claim 18, wherein the communication interfaces provide data communications amongst the lighting devices over links of the data network.
